(19) United States
(12) Patent Application Publication
(10) Pub. No.: US 2015/0294262 A1
(43) Pub. Date: Oct. 15, 2015

(54) DETERMINING DELIVERY WINDOWS FOR ITEM DELIVERY BASED ON CUSTOMER AND/OR ITEM LOCATION

(71) Applicant: United Parcel Service of America, Inc., Atlanta, GA (US)

(72) Inventors: Leslie Nelson, Atlanta, GA (US); Bala Ganesh, Alpharetta, GA (US)

(21) Appl. No.: 14/664,202

(22) Filed: Mar. 20, 2015

Related U.S. Application Data
(60) Provisional application No. 61/968,457, filed on Mar. 21, 2014.

(51) Int. Cl. G06Q 10/08

(52) U.S. Cl. CPC G06Q 10/083

(57) ABSTRACT

Systems, methods, apparatus, and computer program products are provided for programmatically determining/identifying one or more delivery windows in which an item is available to be delivered and allowing customer selection of one of the delivery windows. One example embodiment may include a method comprising receiving customer location information indicative of a customer location and determining one or more time frames from a plurality of time frames in which delivery of the item is available based on the customer location. The method may also comprise allowing an authenticated customer access to each of one or more features of a carrier system via login information/data associated with the retailer system.

### CROSS-REFERENCE TO RELATED APPLICATIONS

This application claims priority to U.S. Provisional Application No. 61/968,457 filed Mar. 21, 2014, which is hereby incorporated herein in its entirety by reference.

### BACKGROUND

Shipping customers are increasing their expectations regarding various delivery services. Thus, new concepts are needed to enhance customer experience and loyalty by improving the delivery experience. For example, whereas other systems are configured such that delivery windows are determined/identified/selected by carrier systems, Applicant has identified a need for customer selected delivery windows prior to tendering to items being to carrier, which improve the delivery experience by, for example, allowing customers to manage and take charge of delivery preferences.

### BRIEF SUMMARY

In general, embodiments of the present invention provide systems, methods, apparatus, and computer program products for determining/identifying one or more delivery windows in which an item is available to be delivered and providing each of the one or more delivery windows for selection by the consumer before, during, or subsequent to selection of item, placement of an item in a shopping cart, a checkout process, shipping of the item or the like.

In some embodiments, a method for determining a delivery time frame for an item to be delivered may be provided, the method comprising receiving customer location information indicative of a customer location, the customer location information selected from the group consisting of entered information, customer profile information, or address information associated with a customer computing entity, and determining one or more time frames from a plurality of carrier time frames in which delivery of the item is available based on the customer location.

In some embodiments, the method may further comprise determining whether the item is available for delivery to the customer location and, in an instance in which the item is available for delivery to the customer location, determining the item location and the customer location, wherein the determination of the one or more time frames is dependent on the item location and the customer location.

In some embodiments, the method may further comprise querying a carrier system to determine one or more delivery timeframes among the plurality of time frames, and receiving the one or more time frames in which delivery is available.

In some embodiments, the method may further comprise receiving an indication of an item and an item location, and providing the one or more time frames, each of the one or more time frames configured for selection, in response to reception of the customer location information and the indication of the item, and in some embodiments, the item location.

In some embodiments, the method may further comprise determining the one or more time frames before, during, or subsequent to a selection of the item, placement of the item in a shopping cart, a checkout process, or shipping of the item.

In some embodiments, the method may further comprise querying a set of one or more pre-established rules to deter mine a customer authentication associated with each of one or more authentication levels, the pre-established rules having been established between a carrier system and a retailer system, and receiving the customer authentication associated with each of the one or more authentication levels.

In some embodiments, the method may further comprise receiving, at a carrier system from a retailer system, an indication notifying the carrier system of whether a customer has been authenticated by the retailer system, in an instance in which the indication notifying the carrier system of the authentication of the customer is received, allowing access to each of one or more features of the carrier system via login information associated with the retailer system. In some embodiments, the method may further comprise, in an instance in which the indication notifying the carrier system of non-authentication of the customer is received, allowing access to a subset of features of the carrier system, and enabling an activation process requiring login, identification, or customer information associated with the carrier system, and initiating a full activation and validation process requiring complete login, identification, or customer information associated with the carrier system.

In some embodiments, the method may further comprise receiving selection of one time frame of the one or more time frames before, during, or subsequent to a selection of the item, placement of the item in a shopping cart, a checkout process, or shipping of the item, confirming selection of the one time frame, and updating shipping information correspondingly for delivery with the selected time frame.

In some embodiments, an apparatus for determining a delivery time frame for an item to be delivered may be provided, the apparatus comprising at least one processor and at least one memory including program code, the at least one memory and the program code configured to, with the processor, cause the apparatus to at least receive customer location information indicative of a customer location, the customer location information selected from the group consisting of entered information, customer profile information, or address information associated with a customer computing entity, and determine one or more time frames from a plurality of carrier time frames in which delivery of the item is available based on the customer location.

In some embodiments, the memory stores computer-readable instructions that, when executed, cause the processor to determine whether the item is available for delivery to the customer location and, in an instance in which the item is available for delivery to the customer location, determining the item location and the customer location, wherein the determination of the one or more time frames is dependent on the item location and the customer location.

In some embodiments, the memory stores computer-readable instructions that, when executed, cause the processor to query a carrier system to determine one or more delivery timeframes among the plurality of time frames, and receive the one or more time frames in which delivery is available.

In some embodiments, the memory stores computer-readable instructions that, when executed, cause the processor to receive an indication of an item and an item location, and provide the one or more time frames, each of the one or more time frames configured for selection, in response to reception of the customer location information and the indication of the item and, in some embodiments, the item location. In some embodiments, the memory stores computer-readable instructions that, when executed, cause the processor to determine the one or more time frames before, during, or subsequent to a selection of the item, placement of the item in a shopping cart, a checkout process, or shipping of the item.

In some embodiments, the memory stores computer-readable instructions that, when executed, cause the processor to query a set of one or more pre-established rules to deter mine a customer authentication associated with each of one or more authentication levels, the pre-established rules having been established between a carrier system and a retailer system, and receive the customer authentication associated with each of the one or more authentication levels.

In some embodiments, the memory stores computer-readable instructions that, when executed, cause the processor to receive, at a carrier system from a retailer system, an indication notifying the carrier system of whether a customer has been authenticated by the retailer system, in an instance in which the indication notifying the carrier system of the authentication of the customer is received, allow access to each of one or more features of the carrier system via login information associated with the retailer system. In some embodiments, the memory stores computer-readable instructions that, when executed, cause the processor to in an instance in which the indication notifying the carrier system of non-authentication of the customer is received, allow access to a subset of features of the carrier system, and enable an activation process requiring login, identification, or customer information associated with the carrier system, and initiate a full activation and validation process requiring complete login, identification, or customer information associated with the carrier system.

In some embodiments, the memory stores computer-readable instructions that, when executed, cause the processor to receive selection of one time frame of the one or more time frames before, during, or subsequent to a selection of the item, placement of the item in a shopping cart, a checkout process, or shipping of the item, confirm selection of the one time frame, and update shipping information correspondingly for delivery with the selected time frame.

In some embodiments, a computer program product may be provided, the computer program product comprising at least one non-transitory computer-readable storage medium having computer-readable program code portions stored therein, the computer-readable program code portions comprising for receiving customer location information indicative of a customer location, the customer location information selected from the group consisting of entered information, customer profile information, or address information associated with a customer computing entity, and determining one or more time frames from a plurality of carrier time frames in which delivery of the item is available based on the customer location.

In some embodiments, the computer-executable program code instructions further comprise program code instructions for determining whether the item is available for delivery to the customer location and, in an instance in which the item is available for delivery to the customer location, determining the item location and the customer location, wherein the determination of the one or more time frames is dependent on the item location and the customer location.

In some embodiments, the computer-executable program code instructions further comprise program code instructions for querying a carrier system to determine one or more delivery timeframes among the plurality of time frames, and receiving the one or more time frames in which delivery is available.

In some embodiments, the computer-executable program code instructions further comprise program code instructions for receiving an indication of an item and an item location, and providing the one or more time frames, each of the one or more time frames configured for selection, in response to reception of the customer location information and the indication of the item, and in some embodiments, the item location.

In some embodiments, the computer-executable program code instructions further comprise program code instructions for determining the one or more time frames before, during, or subsequent to a selection of the item, placement of the item in a shopping cart, a checkout process, or shipping of the item. In some embodiments, the computer-executable program code instructions further comprise program code instructions for querying a set of one or more pre-established rules to deter mine a customer authentication associated with each of one or more authentication levels, the pre-established rules having been established between a carrier system and a retailer system, and receiving the customer authentication associated with each of the one or more authentication levels.

In some embodiments, the computer-executable program code instructions further comprise program code instructions for receiving, at a carrier system from a retailer system, an indication notifying the carrier system of whether a customer has been authenticated by the retailer system, in an instance in which the indication notifying the carrier system of the authentication of the customer is received, allowing access to each of one or more features of the carrier system via login information associated with the retailer system.

In some embodiments, the computer-executable program code instructions further comprise program code instructions for in an instance in which the indication notifying the carrier system of non-authentication of the customer is received, allowing access to a subset of features of the carrier system, and enabling an activation process requiring login, identification, or customer information associated with the carrier system, and initiating a full activation and validation process requiring complete login, identification, or customer information associated with the carrier system.

In some embodiments, the computer-executable program code instructions further comprise program code instructions for receiving selection of one time frame of the one or more time frames before, during, or subsequent to a selection of the item, placement of the item in a shopping cart, a checkout process, or shipping of the item, confirming selection of the one time frame, and updating shipping information correspondingly for delivery with the selected time frame.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is an overview of a system that can be used to practice embodiments of the present invention.

FIG. 2 is an exemplary schematic diagram of a carrier system according to one embodiment of the present invention.

FIG. 3 is an exemplary schematic diagram of a user computing entity according to one embodiment of the present invention.

FIG. 4 is a flowchart illustrating operations and processes that can be used in accordance with various embodiments of the present invention.

FIGS. 5-14, 15A, 15B, 16, and 17 show exemplary input and output of various embodiments of the present invention.

FIG. 18 is a flowchart illustrating operations and processes that can be used in accordance with various embodiments of the present invention.

FIGS. 19A-19E, 20, and 21 show example graphical user interface displays that may be presented by various components of systems, in accordance with some embodiments.

FIG. 22 is a flowchart illustrating operations and processes that can be used in accordance with various embodiments of the present invention.

FIG. 23A-23J show example graphical user interface displays that may be presented by various components of systems, in accordance with some embodiments

### DETAILED DESCRIPTION

Various embodiments of the present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “exemplary” are used to be examples with no indication of quality level. Like numbers refer to like elements throughout.

### I. Computer Program Products, Methods, and Computing Entities

Embodiments of the present invention may be implemented in various ways, including as computer program products that comprise articles of manufacture. A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (e.g., a solid state drive (SSD), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present invention may also be implemented as methods, apparatus, systems, computing devices, computing entities, and/or the like. As such, embodiments of the present invention may take the form of an apparatus, system, computing entity, computing entity, and/or the like executing instructions stored on a computer-readable readable storage medium to perform certain steps or operations. Thus, embodiments of the present invention may also take the form of an entirely hardware embodiment, an entirely computer program product embodiment, and/or an embodiment that comprises combination of computer program products and hardware performing certain steps or operations.

Embodiments of the present invention are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing entities, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments can produce specifically-configured machines performing the steps or operations specified in the block diagrams and flowchart illustrations. Accordingly, the block diagrams and flowchart illustrations support various combinations of embodiments for performing the specified instructions, operations, or steps.

### II. Exemplary System Architecture

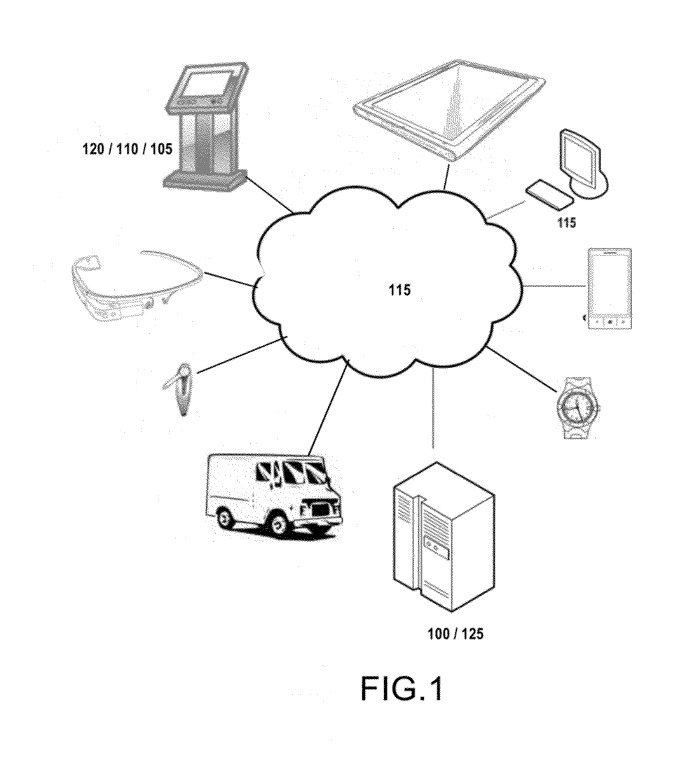

FIG. 1 provides an illustration of a system that can be used in conjunction with various embodiments of the present invention. As shown in FIG. 1, the system may include one or more carrier systems 100, one or more user computing entities 105, one or more consignee computing entities 110, and one or more networks 115, one or more consignor computing entities 120, and one or more retailer systems 125. Each of the components of the system may be in electronic communication with, for example, one another over the same or different wireless or wired networks including, for example, a wired or wireless Personal Area Network (PAN), Local Area Network (LAN), Metropolitan Area Network (MAN), Wide Area Network (WAN), or the like. Additionally, while FIG. 1 illustrates certain communication system entities as separate, standalone entities, the various embodiments are not limited to this particular architecture.

### 1. Exemplary Carrier System

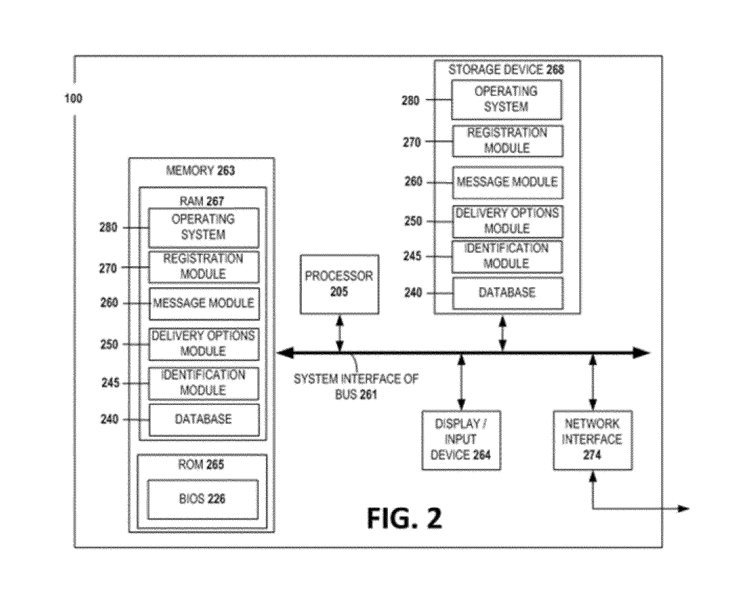

FIG. 2 provides a schematic of a carrier system 100 according to one embodiment of the present invention. In general, the terms computing entity, computer, entity, device, system, and/or similar words used herein interchangeably may refer to, for example, one or more computers, computing entities, desktops, mobile phones, tablets, phablets, notebooks, laptops, distributed systems, vehicles, gaming consoles (e.g., Xbox, Play Station, Wii), watches, glasses, key fobs, radio frequency identification (RFID) tags, ear pieces, scanners, televisions, dongles, cameras, wristbands, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. In various embodiments, the term vehicle is used generically. For example, a vehicle may be a manned or an unmanned tractor, truck, car, motorcycle, moped, Segway, bicycle, golf cart, hand truck, cart, trailer, tractor and trailer combination, van, flatbed truck, vehicle, drone, airplane, helicopter, boat, barge, and/or any other form of object for moving or transporting people and/or items (e.g., one or more packages, parcels, bags, containers, loads, crates, items banded together, vehicle parts, pallets, drums, the like, and/or similar words used herein interchangeably). Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes can be performed on data, content, information, and/or similar terms used herein interchangeably.

The carrier system 100 may also comprise various other systems, such as an Address Matching System (AMS), an Internet Membership System (IMS), a Customer Profile System (CPS), a Package Center information/data System (PCIS), a Customized Pickup and Delivery System (CPAD), a Web Content Management System (WCMS), a Notification Email System (NES), a Fraud Prevention System (FPS), and a variety of other systems and their corresponding components. The carrier system 100 may also be in communication with various payment networks/systems for carrying out or facilitating the payment of fees. As will be recognized, the payment of such fees may be in a variety of forms, such as via debit cards, credit cards, direct credits, direct debits, cash, check, money order, Internet banking, e-commerce payment networks/systems (e.g., PayPal™, Google Wallet, Amazon Payments), virtual currencies (e.g., Bitcoins), award or reward points, and/or the like.

As shown in FIG. 2, in one embodiment, the carrier system 100 may include or be in communication with one or more processing elements 205 (also referred to as processors, processing circuitry, and/or similar terms used herein interchangeably) that communicate with other elements within the carrier system 100 via a bus, for example. As will be understood, the processing element 205 may be embodied in a number of different ways. For example, the processing element 205 may be embodied as one or more complex programmable logic devices (CPLDs), microprocessors, multi-core processors, coprocessing entities, application-specific instruction-set processors (ASIPs), microcontrollers, and/or controllers. Further, the processing element 205 may be embodied as one or more other processing devices or circuitry. The term circuitry may refer to an entirely hardware embodiment or a combination of hardware and computer program products. Thus, the processing element 205 may be embodied as integrated circuits, application specific integrated circuits (ASICs), field programmable gate arrays (FPGAs), programmable logic arrays (PLAs), hardware accelerators, other circuitry, and/or the like. As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present invention when configured accordingly.

In one embodiment, the carrier system 100 may further include or be in communication with non-volatile media (also referred to as non-volatile storage, memory, memory storage, memory circuitry and/or similar terms used herein interchangeably). In one embodiment, the non-volatile storage or memory may include one or more non-volatile storage or memory media 210, including but not limited to hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. As will be recognized, the non-volatile storage or memory media may store databases, database instances, database management systems, data, applications, programs, program modules, scripts, source code, object code, byte code, compiled code, interpreted code, machine code, executable instructions, and/or the like. Such code may include an operating system 280, a registration module 270, a message module 260, a delivery options module 250, an identification module 245, a database 240, and/or the like. The terms database, database instance, database management system, and/or similar terms used herein interchangeably may refer to a structured collection of records or data that is stored in a computer-readable storage medium, such as via a relational database, hierarchical database, and/or network database.

In one embodiment, the carrier system 100 may further include or be in communication with volatile media (also referred to as volatile storage, memory, memory storage, memory circuitry and/or similar terms used herein interchangeably). In one embodiment, the volatile storage or memory may also include one or more volatile storage or memory media 215, including but not limited to RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. As will be recognized, the volatile storage or memory media may be used to store at least portions of the databases, database instances, database management systems, data, applications, programs, program modules, scripts, source code, object code, byte code, compiled code, interpreted code, machine code, executable instructions, and/or the like being executed by, for example, the processing element 205. Thus, the databases, database instances, database management systems, data, applications, programs, program modules, scripts, source code, object code, byte code, compiled code, interpreted code, machine code, executable instructions, and/or the like may be used to control certain aspects of the operation of the carrier system 100 with the assistance of the processing element 205 and operating system, such as a registration module, an alert module, a delivery options module, an identification module, a service schedule module, and/or the like.

As indicated, in one embodiment, the carrier system 100 may also include one or more communications interfaces 220 for communicating with various computing entities, such as by communicating data, content, information, and/or similar terms used herein interchangeably that can be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the carrier system 100 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1X (1×RTT), Wideband Code Division Multiple Access (WCDMA), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), 802.16 (WiMAX), ultra wideband (UWB), infrared (IR) protocols, near field communication (NFC) protocols, Bluetooth protocols, wireless universal serial bus (USB) protocols, and/or any other wireless protocol.

Although not shown, the carrier system 100 may include or be in communication with one or more input elements, such as a keyboard input, a mouse input, a touch screen/display input, motion input, movement input, audio input, pointing device input, joystick input, keypad input, and/or the like. The carrier system 100 may also include or be in communication with one or more output elements (not shown), such as audio output, video output, screen/display output, motion output, movement output, and/or the like.

As will be appreciated, one or more of the carrier system's 100 components may be located remotely from other carrier system 100 components, such as in a distributed system. Furthermore, one or more of the components may be combined and additional components performing functions described herein may be included in the carrier system 100. Thus, the carrier system 100 can be adapted to accommodate a variety of needs and circumstances. As will be recognized, these architectures and descriptions are provided for exemplary purposes only and are not limiting to the various embodiments.

### 2. Exemplary User Computing Entity

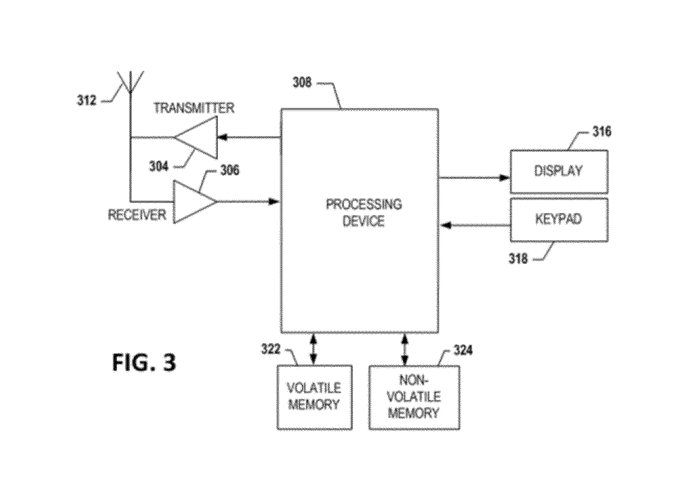

A user may be an individual, a family, a company, an organization, an entity, a department within an organization, a representative of an organization and/or person, and/or the like. To do so, a user may operate a user computing entity 105 that includes one or more components that are functionally similar to those of the carrier system 100. FIG. 3 provides an illustrative schematic representative of a user computing entity 105 that can be used in conjunction with embodiments of the present invention. In general, the terms device, system, computing entity, entity, and/or similar words used herein interchangeably may refer to, for example, one or more computers, computing entities, desktops, mobile phones, tablets, phablets, notebooks, laptops, distributed systems, gaming consoles (e.g., Xbox, Play Station, Wii), watches, glasses, key fobs, radio frequency identification (RFID) tags, ear pieces, scanners, cameras, wristbands, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. User computing entities 105 can be operated by various parties, including carrier or retailer employees or representatives. As shown in FIG. 3, the user computing entity 105 can include an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, respectively.

The signals provided to and received from the transmitter 304 and the receiver 306, respectively, may include signaling information/data in accordance with air interface standards of applicable wireless systems. In this regard, the user computing entity 105 may be capable of operating with one or more air interface standards, communication protocols, modulation types, and access types. More particularly, the user computing entity 105 may operate in accordance with any of a number of wireless communication standards and protocols, such as those described above with regard to the carrier system 100. In a particular embodiment, the user computing entity 105 may operate in accordance with multiple wireless communication standards and protocols, such as UMTS, CDMA2000, 1×RTT, WCDMA, TD-SCDMA, LTE, E-UTRAN, EVDO, HSPA, HSDPA, Wi-Fi, WiMAX, UWB, IR, NFC, Bluetooth, USB, and/or the like. Similarly, the user computing entity 105 may operate in accordance with multiple wired communication standards and protocols, such as those described above with regard to the carrier system 100 via a network interface 320.

Via these communication standards and protocols, the user computing entity 105 can communicate with various other entities using concepts such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The user computing entity 105 can also download changes, add-ons, and updates, for instance, to its firmware, software (e.g., including executable instructions, applications, program modules), and operating system.

According to one embodiment, the user computing entity 105 may include a location determining aspects, device, module, functionality, and/or similar words used herein interchangeably. For example, the user computing entity 105 may include outdoor positioning aspects, such as a location module adapted to acquire, for example, latitude, longitude, altitude, geocode, course, direction, heading, speed, universal time (UTC), date, and/or various other information/data. In one embodiment, the location module can acquire data, sometimes known as ephemeris data, by identifying the number of satellites in view and the relative positions of those satellites. The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. Alternatively, the location information/data can be determined by triangulating the user computing entity's 105 position in connection with a variety of other systems, including cellular towers, Wi-Fi access points, and/or the like. Similarly, the user computing entity 105 may include indoor positioning aspects, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing entities (e.g., smartphones, laptops) and/or the like. For instance, such technologies may include the iBeacons, Gimbal proximity beacons, Bluetooth Low Energy (BLE) transmitters, NFC transmitters, and/or the like. These indoor positioning aspects can be used in a variety of settings to determine/identify the location of someone or something to within inches or centimeters.

The user computing entity 105 may also comprise a user interface (that can include a display 316 coupled to a processing element 308) and/or a user input interface (coupled to a processing element 308). For example, the user interface may be a user application, browser, user interface, and/or similar words used herein interchangeably executing on and/or accessible via the user computing entity 105 to interact with and/or cause display of information/data from the carrier system 100, as described herein. The user input interface can comprise any of a number of devices allowing the user computing entity 105 to receive data, such as a keypad 318 (hard or soft), a touch display, voice/speech or motion interfaces, or other input device. In embodiments including a keypad 318, the keypad 318 can include (or cause display of) the conventional numeric (0-9) and related keys (#, *), and other keys used for operating the user computing entity 105 and may include a full set of alphabetic keys or set of keys that may be activated to provide a full set of alphanumeric keys. In addition to providing input, the user input interface can be used, for example, to activate or deactivate certain functions, such as screen savers and/or sleep modes.

The user computing entity 105 can also include volatile storage or memory 322 and/or non-volatile storage or memory 324, which can be embedded and/or may be removable. For example, the non-volatile memory may be ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. The volatile and non-volatile storage or memory can store databases, database instances, database management systems, data, applications, programs, program modules, scripts, source code, object code, byte code, compiled code, interpreted code, machine code, executable instructions, and/or the like to implement the functions of the user computing entity 105. As indicated, this may include a user application that is resident on the entity or accessible through a browser or other user interface for communicating with the carrier system 100 and/or various other computing entities.

In another embodiment, the user computing entity 105 may include one or more components or functionality that are the same or similar to those of the carrier system 100, as described in greater detail above. As will be recognized, these architectures and descriptions are provided for exemplary purposes only and are not limiting to the various embodiments.

### 3. Exemplary Consignee Computing Entity

The consignee computing entities 110 may each include one or more components that are functionally similar to those of the carrier system 100 and/or user computing entity 105. For example, in one embodiment, each of the consignee computing entities may include: (1) a processor that communicates with other elements via a system interface or bus; (2) a user interface; (3) transitory and non-transitory memory; and (4) a communications interface. As noted, the consignee computing entity 110 may comprise a user interface (that can include a display device/input device coupled to a processing element) and/or a user input interface (coupled to a processing element). For example, the user interface may be a carrier or retailer application, browser, user interface, dashboard, webpage, and/or similar words used herein interchangeably executing on and/or accessible via the consignee computing entity 110 to interact with and/or cause display of information/data from the carrier system 100, as described herein. These architectures are provided for exemplary purposes only and are not limiting to the various embodiments. In general, the terms device, system, computing entity, entity, and/or similar words used herein interchangeably may refer to, for example, one or more computers, computing entities, mobile phones, desktops, tablets, notebooks, laptops, distributed systems, gaming consoles (e.g., Xbox, Play Station, Wii), watches, glasses, key fobs, radio frequency identification (RFID) tags, ear pieces, scanners, cameras, wristbands, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. A customer may refer to either a consignor (e.g., a party shipping an item via carrier) or a consignee (e.g., a party receiving an item from a carrier). In the returns context, a consignee who received an item can become a consignor when returning an item.

### 4. Exemplary Consignor Computing Entity

The consignor computing entities 120 may each include one or more components that are functionally similar to those of the carrier system 100, user computing entity 105, and/or consignee computing entity 110. For example, in one embodiment, each of the consignor computing entities may include: (1) a processor that communicates with other elements via a system interface or bus; (2) a user interface; (3) transitory and non-transitory memory; and (4) a communications interface. As noted, the consignor computing entity 120 may comprise a user interface (that can include a display device/input device coupled to a processing element) and/or a user input interface (coupled to a processing element). For example, the user interface may be a carrier or retailer application, browser, user interface, dashboard, webpage, and/or similar words used herein interchangeably executing on and/or accessible via the consignor computing entity 120 to interact with and/or cause display of information/data from the carrier system 100, as described herein. These architectures are provided for exemplary purposes only and are not limiting to the various embodiments. A customer may refer to a consignor (e.g., a party shipping an item via carrier), a consignee (e.g., a party receiving an item from a carrier) a third party, and/or the like. In the returns context, a consignor who shipped an item can become a consignee when an item is being returned.

### 5. Exemplary Retailer System or Third Party System

The retailer system/third party system 125 may each include one or more components that are functionally similar to those of the carrier system 100, user computing entity 105, consignee computing entity 110, and/or consignor computing entity 120. For example, in one embodiment, the retailer system/third party system 125 may include: (1) a processor that communicates with other elements via a system interface or bus; (2) a user interface; (3) transitory and non-transitory memory; and (4) a communications interface. As noted, retailer system/third party system 125 may provide a user interface, such as a carrier or retailer application, browser, user interface, dashboard, webpage, and/or similar words used herein interchangeably executing on and/or accessible to interact with and/or cause display of information/data from the retailer system/third party system 125 and/or carrier system 100, as described herein. These architectures are provided for exemplary purposes only and are not limiting to the various embodiments.

### III. Exemplary System Operation

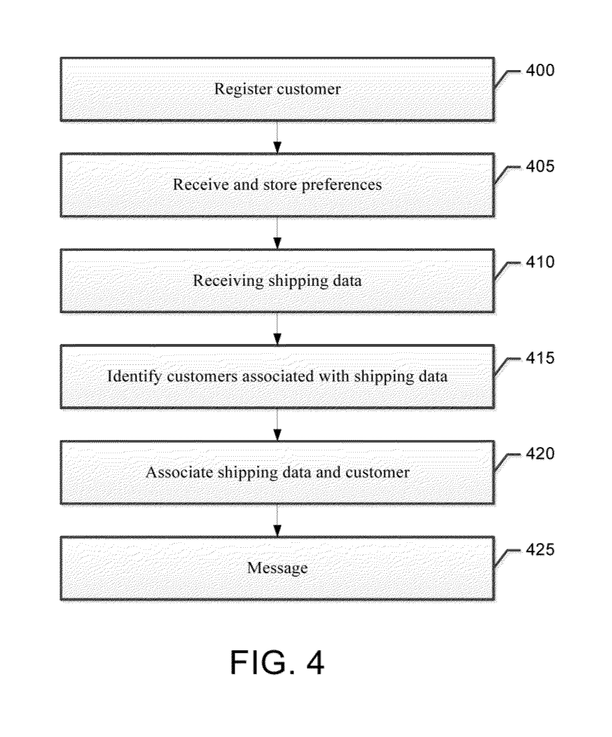

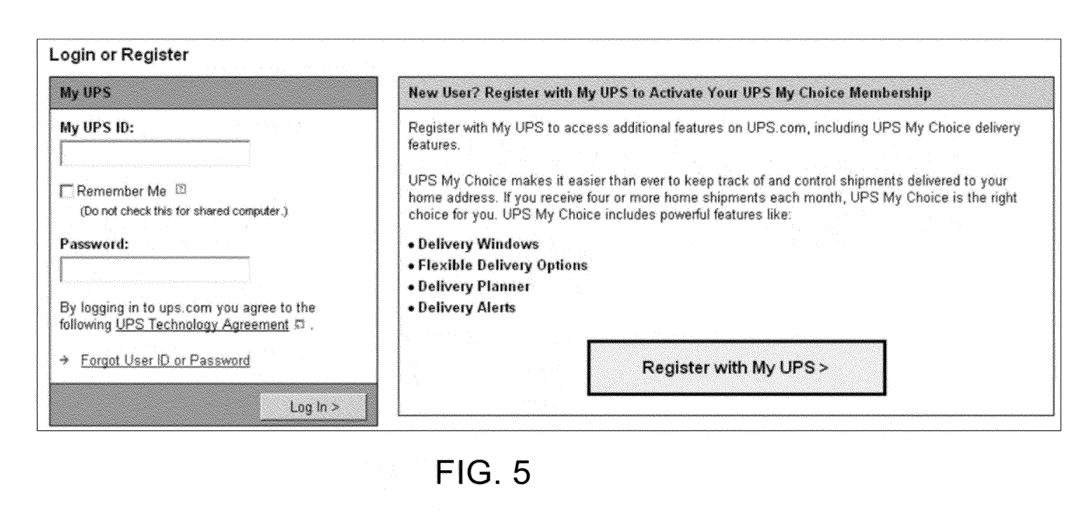

Reference will now be made to FIGS. 4-14, 15A, 15B, 16-18, 19A-19E, 20-22, and 23A-23J. FIGS. 4, 18, and 22 are flowcharts illustrating operations and processes that may be performed for determining delivery windows for item delivery based on customer and/or item location. FIGS. 5-14, 15A, 15B, 16-17, 19A-19E, 20, 21, and 23A-23J show exemplary input and output for determining delivery windows for item delivery based on customer and/or item location. As will be recognized, the following description and figures describe integrated approaches for interacting with customers. That is, certain of the following embodiments may include an integrated solution through which a retailer system/third party system 125 may provide functionality described in the context of the carrier system 100 and/or the carrier system 100 may provide functionality described in the context of the retailer system/third party system 125.

### 1. Registration

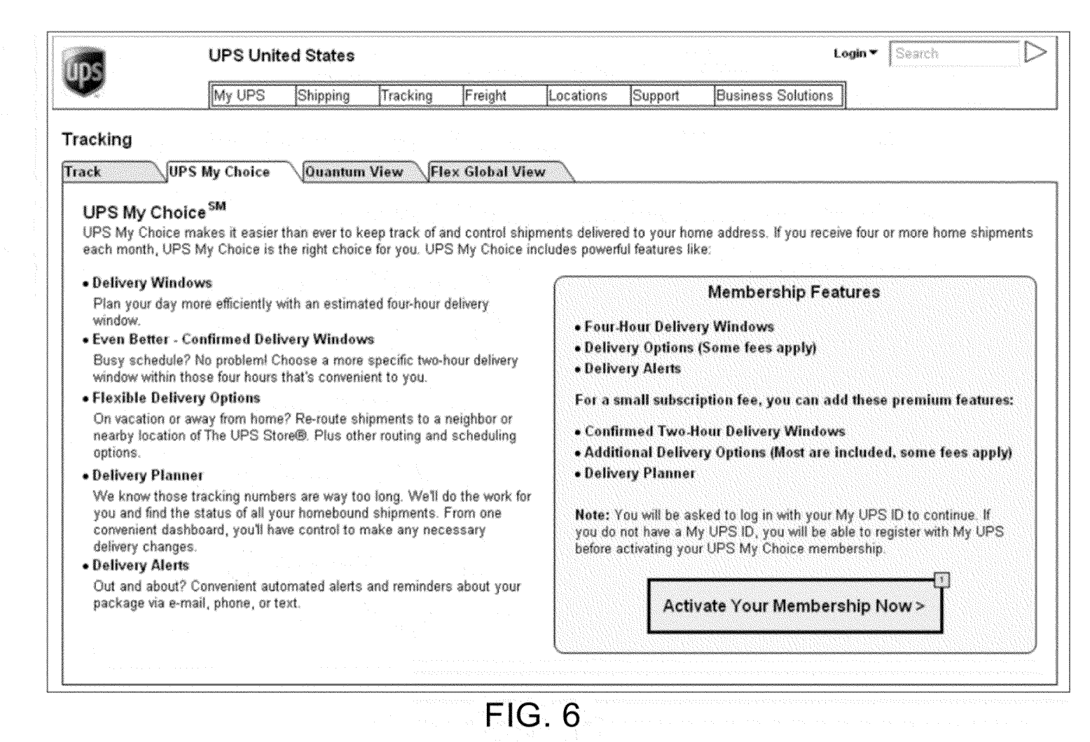

In one embodiment, as indicated in Block 400 of FIG. 4, the process may begin with the enrollment/registration of one or more customers (e.g., consignors and/or consignees) for a customer pickup, delivery, and/or returns program with a carrier and/or for an account, subscription, or program with a retailer or third party. A customer (e.g., consignor, consignee, third party, and/or the like) may be an individual, a family, a company, an organization, an entity, a department within an organization, a representative of an organization and/or person, and/or the like. To register, a customer (e.g., a customer or customer representative operating a consignee computing entity 110 or consignor computing entity 120) may access a webpage, application, dashboard, browser, or portal of a carrier (e.g., United Parcel Service of America, Inc. (Carrier)) or a retailer (e.g., amazon.com). For instance, as shown in FIGS. 5 and 6, the carrier system 100 and/or retailer system/third party system 125 may provide an interface that provides the customer with an option of logging into a customer account or enrolling/registering for a customer pickup, delivery, and/or returns program with the carrier and/or for an account, subscription, or program with a retailer. In the context of a retailer, the registration may be automatic, as part of the checkout process, an opt-in option provided by the retailer, and/or performed using various other approaches and techniques.

In one embodiment, as part of the enrollment/registration process, the customer (e.g., operating a consignee computing entity 110 or consignor computing entity 120) may be requested to provide customer information/data (e.g., including biographic information/data, geographic information/data, and/or the like) by the carrier system 100 and/or retailer system/third party system 125 (e.g., via the registration module). Such information/data may be manually input by a customer; automatically provided by a retailer (e.g., via a retailer system 100); automatically provided by allowing access to other accounts, such as Amazon.com, Facebook, Gmail, Twitter, PayPal, and/or the like; automatically collected by various computing entities; and/or combinations thereof and other techniques and approaches. For instance, the information/data may include the customer's name, such as a first name, a last name, a company name, an entity name, and/or an organization name. The customer (e.g., consignor or consignee) may also provide any aliases associated with the customer. For instance, if the customer (e.g., consignor or consignee) were an individual named Joseph Brown, the customer (e.g., consignor or consignee) may provide Joe Brown or Joey Brown as aliases.

The information/data may include also one or more physical addresses associated with the customer (e.g., street address, city, state, postal code, and/or country). For instance, Joseph Brown's primary residential address of 105 Main Street, Atlanta, Ga. 30309, USA, may be provided to the carrier system 100 and/or retailer system/third party system 125. Further, one or more secondary residential addresses may also be provided to the carrier system 100 and/or retailer system/third party system 125 for association with Mr. Brown's account and profile, such as 71 Lanier Islands, Buford, Ga. 30518, USA. As will be recognized, the residential addresses may include weekend residences, family member residences visited by the customer, and/or the like. Additionally, the customer (e.g., consignor or consignee) may also provide one or more business addresses associated with the customer (e.g., street address, city, state, postal code, and/or country) to the carrier system 100 and/or retailer system/third party system 125. For example, Mr. Brown may have a primary business address of 1201 W Peachtree, Atlanta, Ga. 30309, USA. One or more secondary business addresses may also be provided to the carrier system 100 and/or retailer system/third party system 125 for association with Mr. Brown's account and profile, such as 101 South Tryon Street, Charlotte, N.C. 28280, USA; 950 F Street, NW, Washington, D.C. 20004, USA; and 90 Park Avenue, New York, N.Y. 10016, USA. As will be recognized, the business addresses may include various office locations for a single enterprise, multiple office locations for various enterprises, and/or the like. As will be recognized, the customer (e.g., consignor or consignee) may provide other biographic and/or geographic information/data to adapt to various needs and circumstances.

In one embodiment, in addition to receiving the necessary biographic and/or geographic information/data from the customer, the carrier system 100 and/or retailer system/third party system 125 may perform one or more validation processes and operations, verification processes and operations, fraud processes and operations, and/or similar words used herein interchangeable. As will be recognized, these operations and processes may include the use of various techniques and approaches that require using authenticated links, signup codes, time constraints, and/or other parameters and features for registering/enrolling customers into the customer pickup, delivery, and/or returns program with a carrier and/or for an account, subscription, or program with a retailer. In embodiments in which the retailer system/third party system 125 provides information/data for registration to the carrier system 100, the retailer system/third party system 125 can indicate a customer as being authenticated, and thus one or more of the validation and/or or fraud processes and operations can be bypassed, if desired. As will be recognized, a variety of other approaches and techniques can be used to adapt to various needs and circumstances.

The carrier system 100 and/or retailer system/third party system 125 may determine/identify whether the primary address (and/or other addresses such as, for example, a virtual address, e-mail address, text message ID, a global address, for example, assigned by a global address system, or the like) in the specified country or postal code is eligible for a customer pickup, delivery, and/or returns programs and/or carrier, retailer and/or third party accounts. The carrier system 100 and/or retailer system/third party system 125 may also determine/identify whether the primary address (and/or other addresses) is valid, e.g., by passing the primary address through one or more address cleansing or standardization systems. The carrier system 100 and/or retailer system/third party system 125 may perform a variety of fraud prevention measures as well, such as determining whether the customer (e.g., consignor or consignee) or one of the customer's addresses has been “blacklisted” from customer pickup, delivery, and/or returns programs and/or retailer accounts. As will be recognized, a variety of other approaches and techniques can be used to adapt to various needs and circumstances.

In one embodiment, the carrier system 100 and/or retailer system/third party system 125 may create a customer profile for the customer via the enrollment/registration process. Accordingly, the carrier system 100 and/or retailer system/third party system 125 may create, store, and/or have access to various customer profiles (e.g., via database) and/or information/data associated with the customer profiles. In addition to at least the information/data described above, a customer profile may include one or more corresponding usernames and passwords (e.g., credentials) for accessing accounts associated with the carrier and/or retailer. For example, the carrier system 100 can store and use a customer's retailer credentials for access to the carrier system 100, and/or the retailer system/third party system 125 can store and use a customer's carrier credentials for access to the retailer system/third party system 125.

In one embodiment, in addition to the physical addresses, the customer (e.g., operating a customer computing entity 110/120) may also input, request, or be automatically generated and assigned a “virtual address.” The virtual address can be a combination of alphanumeric characters to identify a customer or customer profile. The virtual address can be stored by the carrier system 100 and/or retailer system/third party system 125 in association with the customer's profile. For example, Joseph Brown (e.g., operating a customer computing entity 110/120) may input a request for a unique virtual address such as BigBrown8675309 or any other unique virtual address. In another embodiment, the carrier system 100 and/or retailer system/third party system 125 may automatically generate and assign a unique virtual address for the customer, such as assigning virtual address 1XR457 to Joseph Brown. Such virtual addresses can be used by customers who do not want to (a) provide their physical addresses to third parties, (b) have their physical addresses printed on labels placed on the exterior of items, and/or (c) the like. For instance, this may enable a consignor to ship a package using only BigBrown8675309 or 1XR457 as the destination address (e.g., virtual address) using the appropriate carrier. Upon induction of the package into the carrier's transportation and logistics network, the carrier personnel can read (e.g., manually or with the aid of a device) the virtual address on the item (e.g., BigBrown8675309 or 1XR457), look up the appropriate physical delivery address for the item based on the consignee's profile (e.g., search for the customer profile associated with the virtual address), and route the item accordingly (including the use of automatic service schedules). In certain embodiments, the item may be routed only using the virtual address. That is, each time the item is handled by carrier personnel, a user computing entity 105 (in communication with the carrier system 100 and/or retailer system/third party system 125) operated by the carrier personnel can cause display of the appropriate handling or routing instructions while masking the actual physical delivery address. In other embodiments, however, once the item with the virtual address is inducted into the carrier's transportation and logistics network, carrier personnel may place a label on the item that indicates the physical delivery address (e.g., based on an address associated with the profile and/or automatic service schedule). Such virtual address concepts are disclosed in U.S. Pat. No. 8,108,321, which is hereby incorporated in its entirety by reference. Both physical addresses and virtual addresses may be referred to herein interchangeably as “addresses.”

In addition to the virtual address, the carrier system 100 and/or retailer system/third party system 125 may also generate and store an internal customer identifier in association with the customer profile (e.g., tokenized). In one embodiment, a customer identifier may be used to uniquely identify a customer profile. In another embodiment, a customer identifier may be used to uniquely identify a given address (e.g., physical address or virtual address) associated with a customer profile. In such an embodiment, if a customer profile is associated with four addresses, the carrier system 100 and/or retailer system/third party system 125 may generate and store (e.g., tokenize) four customer identifiers in association with the customer profile (or use one customer identifier for all the addresses for the customer). The customer identifier may also be stored in association with shipping information/data for an item to associate the item (and its shipping information/data) with the (a) correct customer (e.g., customer profile) and/or (b) correct address for a customer.

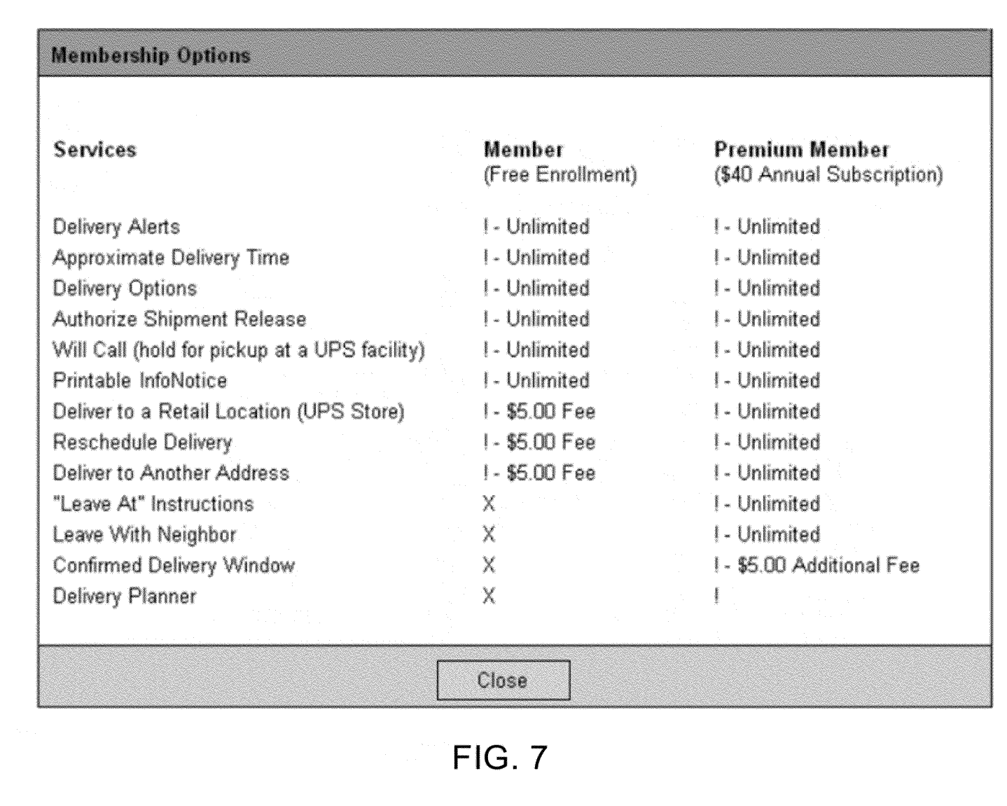

In one embodiment, a customer profile may correspond to one or more customer pickup, delivery, and/or returns programs and/or retailer and/or third party accounts, subscriptions, and/or programs. For instance, a customer (e.g., operating a customer computing entity 110/120) may subscribe to a specific customer pickup, delivery, and/or returns program and/or retailer accounts, subscriptions, and/or programs. In one embodiment, there may be several customer pickup, delivery, and/or returns programs and/or retailer accounts, subscriptions, and/or programs from which to choose, such as free programs or accounts and premium programs or accounts (e.g., Amazon Prime). Each customer pickup, delivery, and/or returns program and/or retailer account, subscription, and/or program may have different benefits, such as those shown in FIG. 7 and Table 1 below.

As shown in Table 1 above and in FIG. 7 for illustrative purposes, the free customer pickup, delivery, and/or returns program and the premium customer pickup, delivery, and/or returns program may have different benefits. For example, the free customer pickup, delivery, and/or returns program may allow customers to have access to certain features, e.g., pickup and delivery alerts, approximate pickup and delivery times, change pickup and delivery options, electronically authorize the release of an item, and/or route items to will call. Similarly, the premium customer pickup, delivery, and/or returns program (e.g., requiring a fee) may allow customers to have access to certain features in addition to those provided via the free customer pickup, delivery, and/or returns program, e.g., route items to other retail locations, reschedule pickups and deliveries, request that items be delivered to another address, and/or provide instructions for pickup or delivery. Payments for such fees may be in a variety of forms, such as via debit card, credit card, direct credits, direct debits, cash, check, money order, Internet banking, e-commerce payment networks/systems (e.g., PayPal™, Google Wallet, Amazon Payments), virtual currencies (e.g., Bitcoins), award or reward points, and/or the like. As will be recognized, these features are provided for illustrative purposes and are not limiting to embodiments of the present invention. Moreover, a variety of other approaches and techniques can be used to adapt to various needs and circumstances.

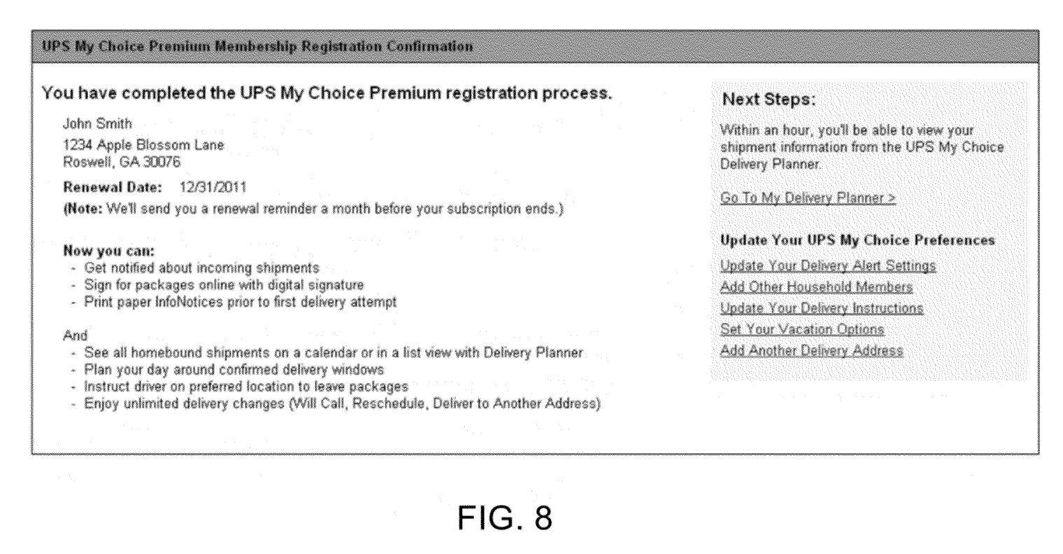

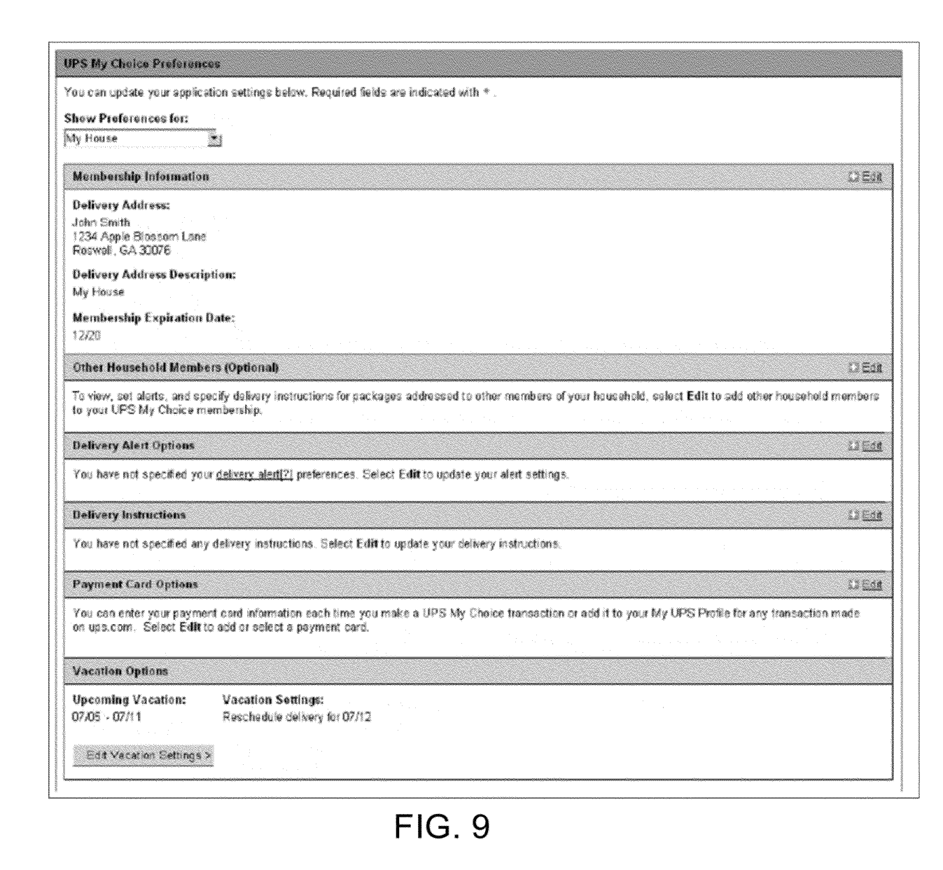

In one embodiment, once a customer profile has been created by the carrier system 100 and/or retailer system/third party system 125, the customer (e.g., operating a customer computing entity 110/120) can provide various preferences, options, and features associated with the accounts, subscriptions, and/or programs to the carrier system 100 and/or retailer system/third party system 125 via an interface (Block 405 of FIG. 4), for example. For instance, as shown in FIGS. 8 and 9, the customer (e.g., operating a customer computing entity 110/120) can provide a variety of preferences, such communication preferences, service schedule preferences, delivery preferences, delivery options, and/or delivery instructions. The customer (e.g., operating a customer computing entity 110/120) may also update any information/data through the appropriate interface (e.g., browser, dashboard, webpage, application).

### 2. Customer and Item Matching

In one embodiment, as part of the online shopping experience, the retailer system/third party system 125 may send a request to the carrier system 100 to determine/identify whether the customer is enrolled in one or more customer pickup, delivery, and/or returns program. As discussed further below, the request may comprise customer information/data and/or shipping information/data that includes customer information/data. In another embodiment, once a customer (e.g., consignor or consignee) profile has been created by the carrier system 100 and/or retailer system/third party system 125, one or more items to be picked up from, delivered to, and/or returned from the customer can be identified as corresponding to the customer. By identifying items or profiles corresponding to the customer, the carrier system 100 and/or retailer system/third party system 125 can provide the customer with access to various features of the customer pickup, delivery, and/or returns program and/or can make various determinations. As will be recognized, an item may be one or more packages, parcels, bags, containers, loads, crates, items banded together, vehicle parts, pallets, drums, the like, and/or similar words used herein interchangeably. In one embodiment, each item may include an item/shipment identifier, such as an alphanumeric identifier. Such item/shipment identifiers (as well as physical and virtual addresses) may be represented as text, barcodes, Aztec Codes, MaxiCodes, Data Matrices, Quick Response (QR) Codes, electronic representations, and/or the like. The unique item/shipment identifier (e.g., 123456789) may be used by the carrier to identify and track the item as it moves through the carrier's transportation and logistics network. Further, such item/shipment identifiers can be affixed to items by, for example, using a sticker (e.g., label) with the unique item/shipment identifier printed thereon (in human and/or machine readable form) or an RFID tag with the unique item/shipment identifier stored therein.

In one embodiment, the carrier system 100 and/or retailer system/third party system 125 may store an item/shipment identifier in association with shipping information/data for the item. The shipping information/data may include information/data about the item, such as delivery service level. For example, the delivery service level may be Next Day Air, Overnight, Express, Next Day Air Early AM, Next Day Air Saver, Jetline, Sprintline, Secureline, 2nd Day Air, Priority, 2nd Day Air Early AM, 3 Day Select, Ground, Standard, First Class, Media Mail, SurePost, Freight, and/or the like. The shipping information/data may include customer information/data about the party shipping the item (e.g., customer information/data, consignor information/data), such as the party's address, the party's phone number, the party's return address, the party's name, and/or the like. The shipping information/data may also include customer information/data about the customer to whom the item is to be delivered (e.g., customer information/data, consignee information/data), such as the customer's physical address or location (e.g., delivery point/location), the customer's virtual address, the customer's phone number, the customer's name, and/or the like. As will be recognized, the terms delivery point/location are intended encompass any identifiable location, including residences, commercial locations, stores, vehicles, boats, landmarks, and/or the like.

In one embodiment, the shipping information/data may include information/data about the item itself and any tracking information/data. The tracking information/data may reflect the item's movement in the carrier's transportation and logistics network, including an expected pickup or delivery date and time. To reflect the item's movement, an item/shipment identifier associated with the item may be scanned or otherwise electronically read at various points as the item is transported through the carrier's transportation and logistics network. For example, the item/shipment identifier may be automatically scanned by a barcode or MaxiCode device, an RFID interrogator, by a camera controller, or by a carrier employee using a handheld device (e.g., user computing entity 105). In one embodiment, each time the item/shipment identifier is scanned or read, an appropriate device can transmit the item/shipment identifier and other appropriate information/data (e.g., location and time of the scan or reading) to the carrier system 100 and/or retailer system/third party system 125. The carrier system 100 and/or retailer system/third party system 125 can then receive and use the information/data to track the item as it is transported though the carrier's transportation and logistics network and update the shipping information/data accordingly.

In one embodiment, the carrier system 100 and/or retailer system/third party system 125 can use customer information/data and/or shipping information/data that includes customer information/data to identify one or more customer profiles (e.g., via the identification module). As described, each customer profile may include one or more physical addresses or virtual addresses associated with the customer. Thus, when the carrier system 100 and/or retailer system/third party system 125 receives customer information/data and/or shipping information/data (Block 410 of FIG. 4), the carrier system 100 and/or retailer system/third party system 125 can determine/identify whether the customer information/data and/or shipping information/data corresponds to any customers enrolled/registered for a customer pickup, delivery, and/or returns program and/or an account, subscription, or program with a retailer. In particular, the carrier system 100 and/or retailer system/third party system 125 can use the physical delivery address or the virtual address of the customer information/data and/or shipping information/data to identify (a) any customer profiles with a substantially similar physical delivery address or (b) a customer profile that matches the virtual address (Block 415 of FIG. 4). For example, if the customer information/data and/or shipping information/data indicates that the physical delivery address of the intended recipient is 105 Main St., Atlanta, Ga. 30309, the carrier system 100 and/or retailer system/third party system 125 may identify Joseph Brown's customer profile even though the address in Joseph Brown's profile is 105 Main Street, Atlanta, Ga. 30309, USA. In other words, in making such determinations, the carrier system 100 and/or retailer system/third party system 125 can accommodate variations for a given address. As will be recognized, the carrier system 100 and/or retailer system/third party system 125 may be configured to compensate for various discrepancies. Other unique information/data can also be used for the same purpose, such as email addresses, phone numbers, usernames, and/or the like.

In one embodiment, as a secondary measure for matching addresses to customer profiles, the carrier system 100 and/or retailer system/third party system 125 can use the first, last, and middle names in the customer information/data and/or shipping information/data to confirm that the identified customer profile is correct. To do so, the carrier system 100 and/or retailer system/third party system 125 may compare one or more portions of a name from the customer information/data and/or shipping information/data to the primary name and/or any aliases in the identified customer profile. If the names are substantially similar, the carrier system 100 and/or retailer system/third party system 125 can confirm that the identified customer profile is correct. By way of example, if the customer information/data and/or shipping information/data indicates the name Joe Brown and Joseph Brown listed Joe as a first name alias, the carrier system 100 and/or retailer system/third party system 125 could confirm Joseph Brown's customer profile. As will be recognized, a variety of other approaches and techniques can be used to identify a customer profile corresponding to the customer information/data and/or shipping information/data.

In another embodiment, the carrier system 100 and/or retailer system/third party system 125 can use the virtual address of the intended recipient (e.g., consignee or customer) in the customer information/data and/or shipping information/data to identify the appropriate customer profile (Block 415 of FIG. 4). For example, if the customer information/data and/or shipping information/data indicates that the virtual address is BigBrown8675309 (or 1XR457), for example, the carrier system 100 and/or retailer system/third party system 125 may identify Joseph Brown's customer profile. As will be recognized, a variety of other approaches and techniques can be used to adapt to various needs and circumstances.

In one embodiment, after identifying the appropriate customer profile based on the customer information/data and/or shipping information/data for an item to be or being transported by the carrier, the carrier system 100 and/or retailer system/ third party system 125 can associate the shipping information/data with the customer profile (Block 420 of FIG. 4). In certain embodiments, this may include appending the shipping information/data with the appropriate customer identifier. For instance, the shipping information/data for all shipments corresponding to Joseph Brown's customer profile may be appended with the customer identifier created for Joseph Brown. In various embodiments, using this approach allows items (and their shipping information/data) to be linked to appropriate customer profiles. Thus, when Joseph Brown accesses his account, he can view all of his shipments (e.g., those shipments with shipping information/data appended with his customer identifier (or other identifier)). Similarly, any actions for an item or customer can be passed to the shipping information/data for the item (including carrying out automatic service schedules).

### 3. Item Tracking

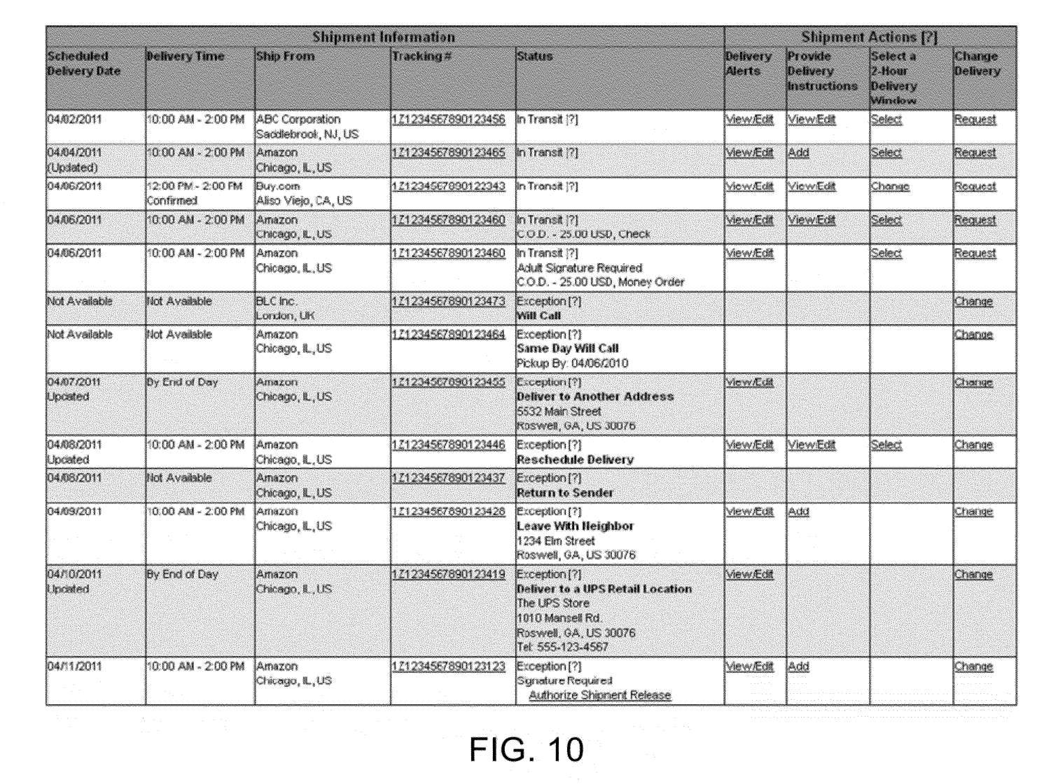

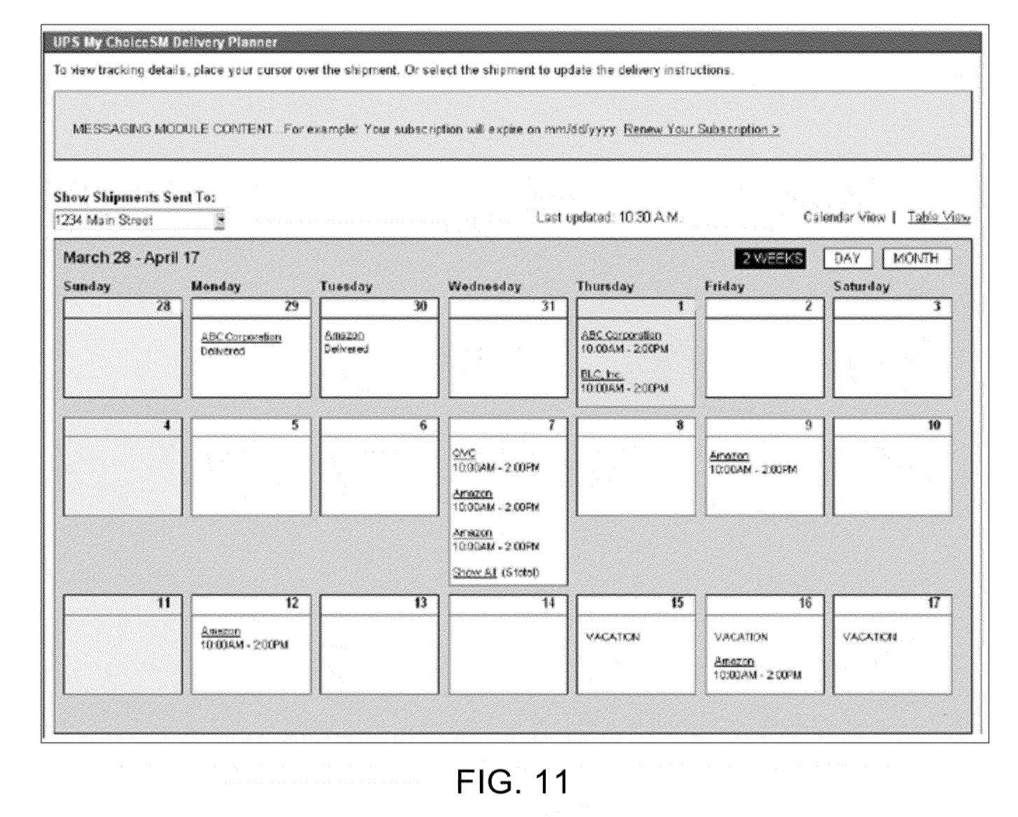

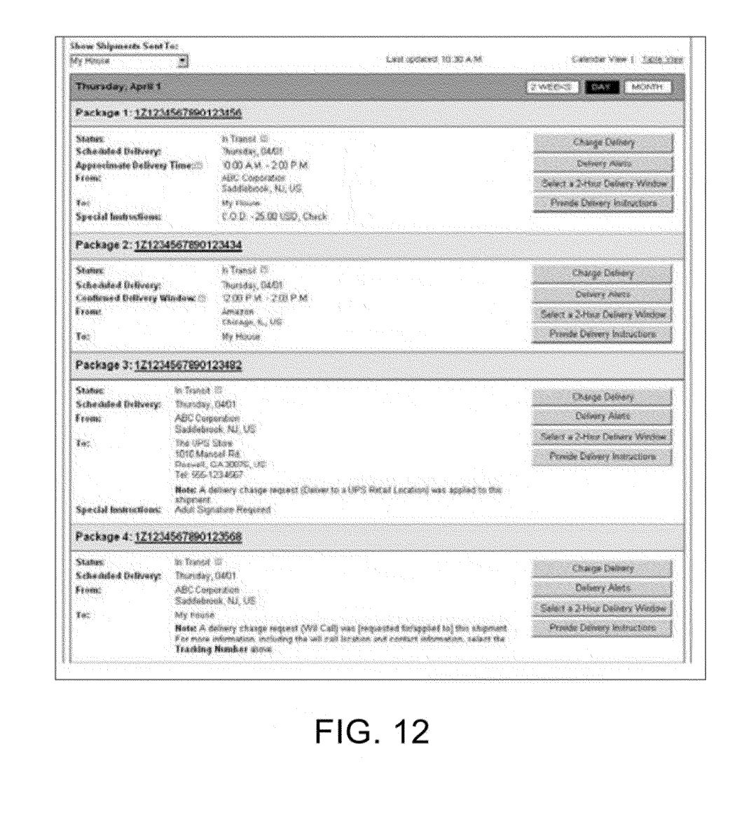

In one embodiment, by appending the shipping information/data with the appropriate customer identifier, the corresponding customer, retailer and/or third party can view tracking information/data for any shipments associated with the customer profile. For instance, as shown in FIGS. 10-12, the carrier system 100 and/or retailer system/third party system 125 can be used to identify (e.g., retrieve the shipping information/data with the appropriate customer identifier) all shipments associated with a customer (e.g., customer profile) using the customer identifier and provide them to the customer for viewing in a customer-friendly format, such as via an interface (e.g., browser, dashboard, webpage, application). FIG. 10 shows an exemplary interface (e.g., browser, dashboard, webpage, application) with a list of all inbound shipments to a customer. FIG. 11 shows an interface with a calendar (which may have a day view, a week view, a multiple week view, and/or a month view) having a list of all inbound shipments to a customer. The calendar may also show item events as the item progresses through the carrier's transportation and logistics network (e.g., the date and location of a pickup, the date and location of intermediate location events, and/or the date and location of the delivery event). The calendar may also comprise various other retailer events (e.g., expected in-stock data, expected ship date, ship date, and/or the like). In FIG. 11, the calendar can be sorted by physical delivery address, indicating that the customer has more than one physical delivery address associated with the customer profile. FIG. 12 shows an interface (e.g., browser, dashboard, webpage, application) with a list of all inbound shipments to a customer. As will be recognized, a variety of other approaches and techniques can be used to adapt to various needs and circumstances, such as only displaying the deliveries for a defined time period (e.g., the past 90 days)

In various embodiments, these concepts can provide customers with ongoing visibility of all inbound packages (e.g., FIGS. 10, 11, and 12), as well as preferences, regardless of carrier. For instance, for each item, the interface (e.g., browser, dashboard, webpage, application) can be used to show the item/shipment identifier, a delivery indicator, a last activity scan date, a non-confirmed delivery window, a confirmed delivery window a commit time, whether an in-person signature is requested for delivery, a delivery service level, and/or various other information. Thus, through such an interface, customers (e.g., operating customer computing entities 110/120) can review and access all inbound shipments (from one or more carriers) using a single interface. As will be recognized, though, a variety of other approaches and techniques can be used to provide tracking information/data to a customer.

### 4. Messages/Alerts

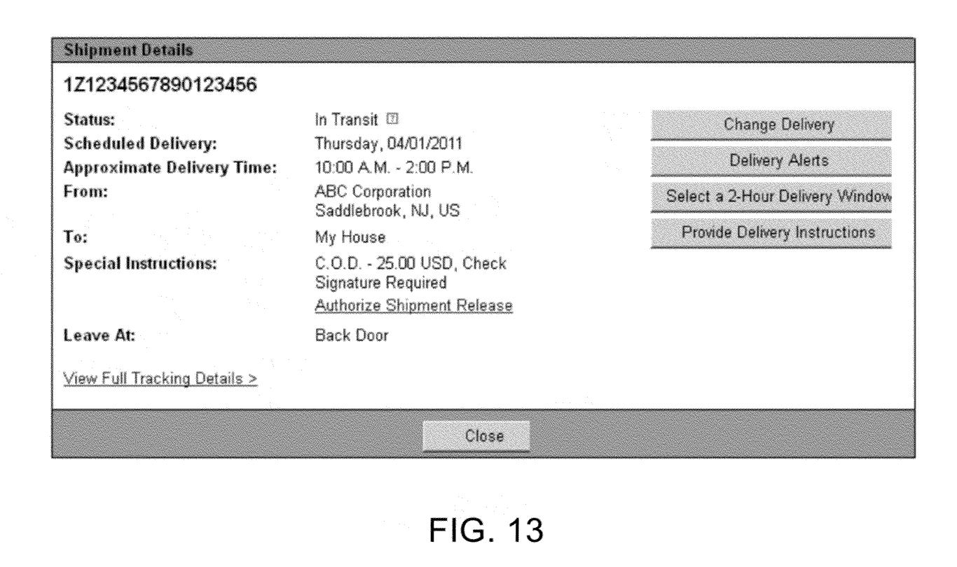

In one embodiment, customers (e.g., operating customer computing entities) can customize and/or provide communication preferences regarding items to be picked up from or delivered to the customers (shown in FIG. 13). For example, the communication preferences may provide customers with the ability to request messages for items before the carrier attempts to pick up or deliver items (e.g., prior to the first delivery attempt by the carrier) and/or after items have been picked up or delivered.

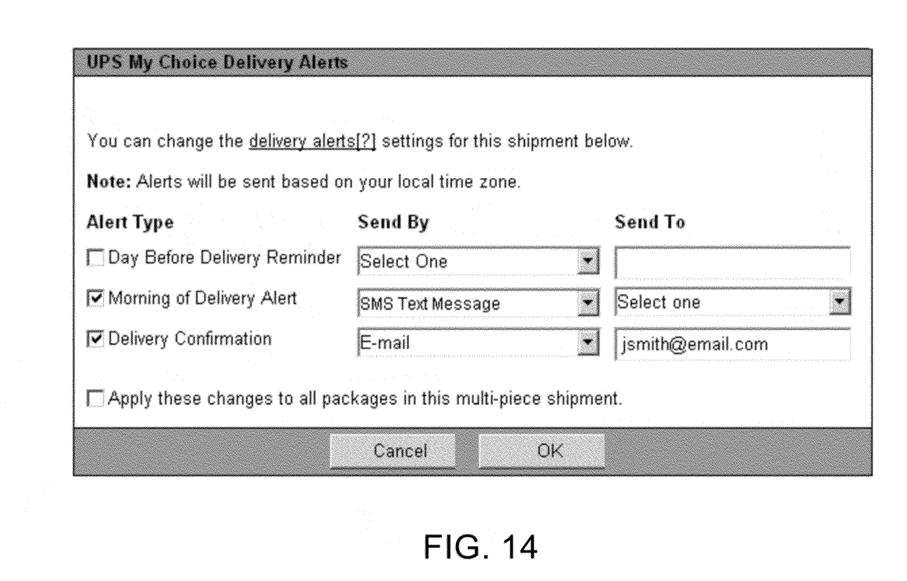

In one embodiment, as shown in FIG. 14, a customer (e.g., operating a consignee computing entity 110 or consignor computing entity 120) can identify one or more communication formats for communicating with the customer. The communication formats may include text messages (e.g., Short Message Service (SMS) and/or Multimedia Messaging Service (MMS), email messages, voice messages, video message (e.g., YouTube, the Vine), picture message (e.g., Instagram), social media message (e.g., private social media created internally for entities, business social media (e.g., Yammer, SocialCast), or public social media (e.g., Facebook, Instagram, Twitter)), and/or a variety of other messages in various communication formats. In addition to identifying one or more communication formats, the customer (e.g., operating a customer computing entity 110/120) can identify the corresponding electronic destination addresses to be used in providing information/data regarding items to be picked up from or delivered to the customer. For instance, for text messages, the customer may provide one or more cellular phone numbers. For email messages, the customer may provide one or more email addresses. And for voice messages, the customer may provide one or more cellular or landline phone numbers. Additionally, in one embodiment, validation operations can be performed with respect to each input electronic destination address—to ensure their accuracy. As will be recognized, a variety of other types of electronic destination addresses can be used to adapt to various needs and circumstances.

In one embodiment, customers (e.g., operating a consignee computing entity 110 or consignor computing entity 120) may indicate the type of messages they want to receive (e.g., the content). For example, a customer may indicate that he only wants to receive messages when the shipping information/data for an item indicates that an in-person signature from the customer is requested for delivery of the item, when the pickup or delivery options for the item can be changed, when instructions for pickup or delivery of the item can be provided, or when the pickup or delivery service level of the item can be changed. In another example, a customer may indicate that he wants to receive messages for all items to be picked up from or delivered to the customer with expected dates and times. In yet another embodiment, a customer may indicate the he wants to receive messages for items that are automatically re-routed or when a fee will be assessed for delivering an item in accordance with the customer's automatic service schedule. As will be recognized, customers may indicate that they want to receive messages regarding items in a variety of other circumstances as well.

In one embodiment, customers (e.g., operating a consignee computing entity 110 or consignor computing entity 120) may identify/define time periods in which the messages providing information/data regarding items to be delivered should be transmitted to the customer. For instance, the time periods may include (a) after shipment and the day before an item is delivered and (b) after shipment and the morning of the day of delivery. In such cases, the messages can serve as a reminder to the customer that an item is being delivered (e.g., 48 hours before, 24 hours before, 8 hours before, 4 hours before, 2 hours before, 1 hour before, 30 minutes before, 15 minutes before, when the driver enters a geofence or other designated area, and/or the like). Similarly the time periods may be after delivery for confirmation of delivery or even after an unsuccessful delivery attempt to the customer. In such a case, the customer may define where and how messages regarding such unsuccessful delivery attempts should be made as part of the communication preferences or allow the carrier system 100 and/or retailer system/third party system 125 to track the customer for delivery after an unsuccessful attempt. As will be recognized, the carrier system 100 and/or retailer system/third party system 125 can store communication preferences for providing information/data in association with the customer profiles. Moreover, the communication preferences may apply to the customer profile globally, to selected customer addresses, to groups of items, and/or an item-by-item basis.

In one embodiment, the carrier system 100 and/or retailer system/third party system 125 may impose time constraints for placing, generating, and/or transmitting messages within the time periods identified by the customers. For example, the carrier system 100 and/or retailer system/third party system 125 may only transmit text messages to customers between 6:00 am-11:00 pm (based on time zones). Similarly, the carrier system 100 and/or retailer system/third party system 125 may place calls and transmit automated voice messages between 8:00 am-9:00 pm (based on time zones). And for email messages, the carrier system 100 and/or retailer system/third party system 125 may generate and transmit them without time constraints.

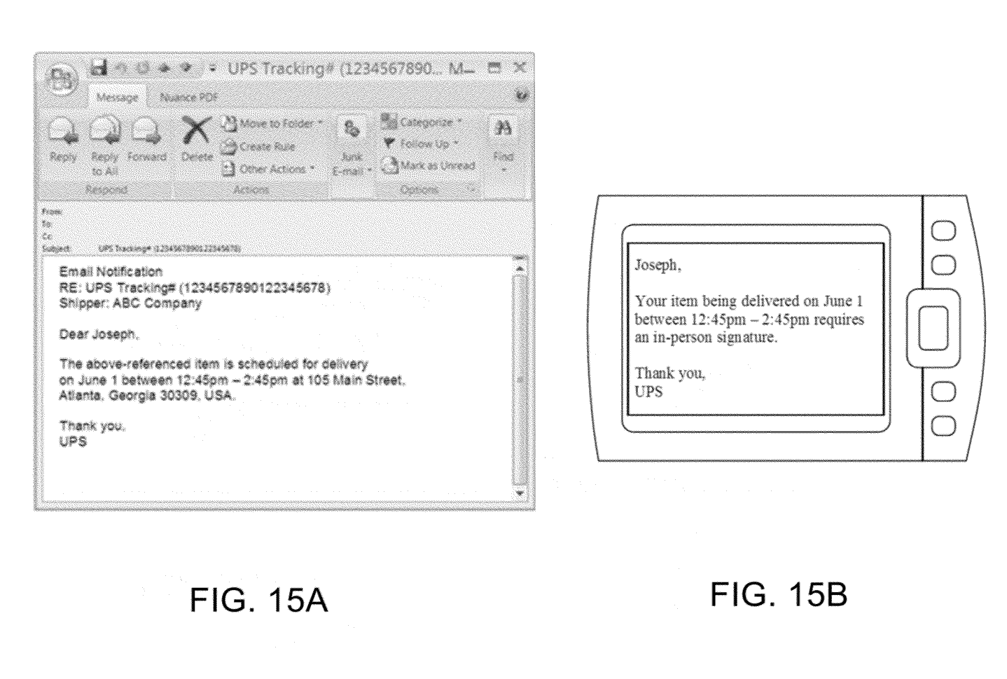

In one embodiment, the carrier system 100 and/or retailer system/third party system 125 can automatically generate (e.g., via the message module) one or more messages providing information/data regarding an item to be delivered to the customer (Block 425 of FIG. 4) in compliance with the customer's communication preferences and the carrier's time constraints. Similarly, the carrier system 100 and/or retailer system/third party system 125 can automatically transmit the one or messages to the electronic destination addresses in compliance with the customer's communication preferences and the carrier's time constraints. For example, the carrier system 100 and/or retailer system/third party system 125 may generate and transmit an email message to Joseph Brown's email address and a text message to Joseph's cellular phone the day before an item is to be delivered to Joseph's home address. The messages may indicate the expected delivery date and/or delivery time, such as shown in FIGS. 15A and 15B, and a variety of other information. As will be recognized, a variety of other operations and processes may be used with embodiments of the present invention. These operations and processes can be customized to adapt to various needs and circumstances.

### 5. Pickup/Delivery Times

In one embodiment, an interface (e.g., browser, dashboard, application from a carrier and/or retailer) provided by the carrier system 100 and/or the retailer system/third party system 125 can be used to view expected, estimated, confirmed, and/or guaranteed pickup and/or delivery times (including pickup or delivery windows) or determine/identify expected, estimated, confirmed, and/or guaranteed pickup and/or delivery times. As described herein, the terms pickup and delivery times and times windows encompass particular days and/or dates as well. For instance, a delivery time may also include a delivery date. In one embodiment, expected, estimated, confirmed, and/or guaranteed time windows may indicate an expected, estimated, confirmed, and/or guaranteed pickup or delivery time of an item based on historical pickup or delivery times to the area (e.g., historical information/data). Such pickup and/or delivery information/data may be sent by the carrier system 100 to a retailer system/third party system 125 to display to customers (e.g., operating appropriate customer computing entities 110/120) as part of their online shopping experience. For example, in one embodiment, various triggers may cause a retailer system/third party system 125 to send customer information/data and/or shipping information/data to the carrier system 100 to obtain expected, estimated, confirmed, and/or guaranteed pickup or delivery times for one or more items to be delivered to the customer from the retailer. For instance, when a customer (e.g., operating an appropriate customer computing entity 110/120) accesses a retailer system (e.g., shopping via browser, dashboard, application from a retailer), the retailer system/third party system 125 can identify the customer and send customer information/data and/or shipping information/data to the carrier system 100. The retailer system/third party system 125 can identify the customer from cookies stored on the customer computing entity 110/120, by the customer (e.g., operating an appropriate customer computing entity 110/120) logging into the customer's account with the retailer, by requesting geographic information/data, and/or the like. With the customer identified, the retailer system/third party system 125 can provide customer information/data and/or shipping information/data to the carrier system 100. As previously described, with the customer information/data and/or shipping information/data, the carrier system 100 and/or the retailer system/third party system 125 can identify a customer profile corresponding to the information/data (e.g., based on addresses, names, email addresses, home, business, car, and/or mobile phone numbers, and/or the like).

In one embodiment, while the customer is, for example, shopping at or otherwise browsing items on a retailer website, after identifying the appropriate customer profile based on the customer information/data and/or shipping information/data, the carrier system 100 and/or the retailer system/third party system 125 can determine/identify expected, estimated, confirmed, and/or guaranteed pickup or delivery times (including pickup or delivery windows) before, during, or subsequent to selection of item, placement of an item in a shopping cart, a checkout process, shipping of the item or the like. These determinations can be made for each of one or more items that may be or are to be transported by the carrier and/or for items that are being purchased or may be purchased from the retailer. For example, while browsing, a user may place or search that results in or navigate to a page resulting in display of one or more items. Having identified the appropriate customer profile, the carrier system 100 and/or the retailer system/third party system 125 can determine/identify expected, estimated, confirmed, and/or guaranteed pickup or delivery times (including pickup or delivery windows) for each of one or more of the displayed items. In other embodiments, before browsing a retailer website, such as for example, upon navigation to and display of the retailer website, the carrier system 100 and/or the retailer system/third party system 125 can determine/identify expected, estimated, confirmed, and/or guaranteed pickup or delivery times (including pickup or delivery windows) that may be available for selection. In one embodiment, the carrier system 100 and/or the retailer system/third party system 125 can make these determinations, for example, based on historical information/data. For instance, the historical information/data may include delivery times and/or windows from the past 24 months, 12 months, 6 months, 90 days, and/or any other time period. Based on the historical information/data, the carrier system 100 and/or the retailer system/third party system 125 can determine/identify one or more expected, estimated, confirmed, and/or guaranteed pickup or delivery times (including pickup or delivery windows). For instance, if the historical information/data indicates that items are generally able to be delivered to 123 Main Street by around 2:00 pm, the carrier system 100 and/or the retailer system/third party system 125 may determine/identify one or more delivery times (e.g., 2:00 pm or later and/or one or more delivery windows such as 1:00 pm-3:00 pm, 2:00 pm- 4:00 pm, etc. Further, the carrier system 100 and/or the retailer system/third party system 125 can also make such determinations in light of expected or forecasted item volumes to adjust the same. For instance, the carrier system 100 and/or the retailer system/third party system 125 can adjust the times or time windows to be later if expected volumes are high or to be earlier if expected volumes are low. The carrier system 100 and/or the retailer system/third party system 125 can also make such determinations in light of customer-defined service schedules and/or a variety of factors, conditions, requirements, parameters, and/or similar words (e.g., seasons, holidays, weather conditions, travel conditions, environmental conditions, safety conditions, and/or the like. Such automatic service schedules are also described in U.S. appl. Ser. No. 14/025,893, which is hereby incorporated in its entirety by reference.

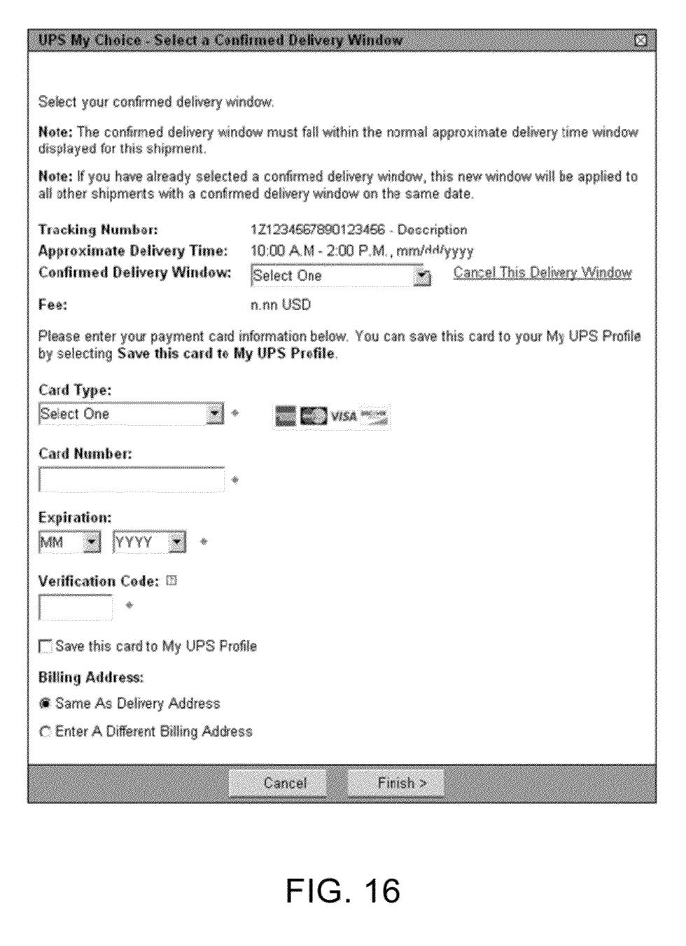

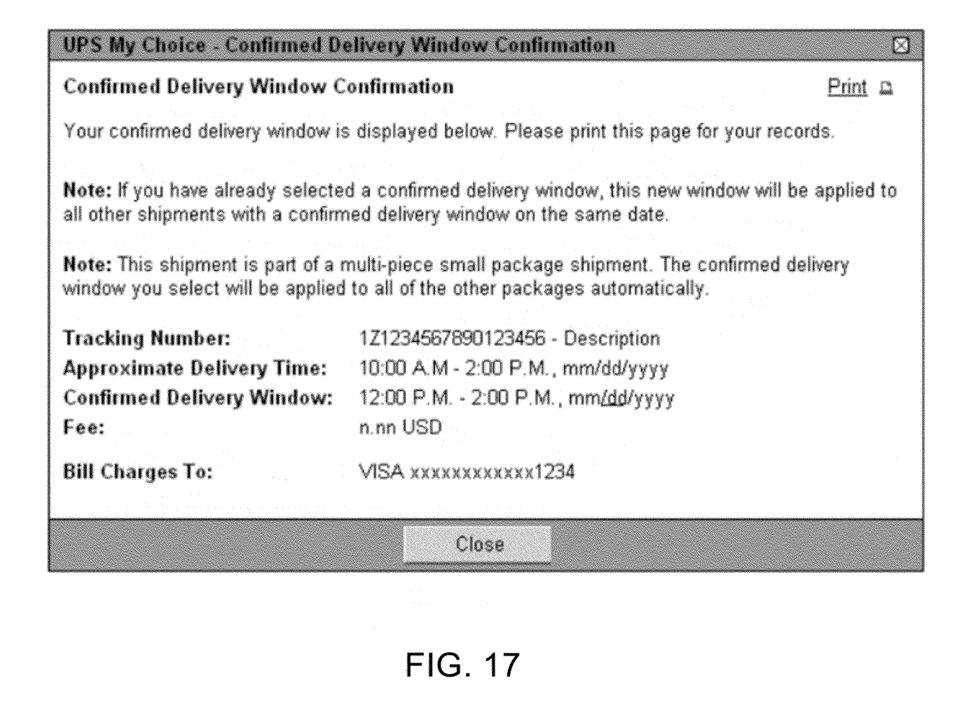

In another embodiment, the carrier system 100 and/or the retailer system/third party system 125 can determine/identify or identify multiple expected, estimated, confirmed, and/or guaranteed pickup or delivery times (including pickup or delivery windows). In an online environment, this may allow for customers to select a specific delivery time or delivery time window before an item is purchased, as part of the checkout process, after an item has been received by the carrier for transport, and/or the like. As will be recognized, the carrier system 100 and/or the retailer system/third party system 125 may also provide costs associated with each delivery time or time window. For example, if the carrier system 100 and/or the retailer system/third party system 125 determines that the expected, estimated, confirmed, and/or guaranteed delivery time is 2:00 pm and/or that the applicable delivery window is 1:00 pm-3:00 pm, the carrier system 100 and/or the retailer system/third party system 125 can provide this service at no additional charge or for any amount desired or determined. However, the carrier system 100 and/or the retailer system/third party system 125 can also provide other delivery times and time windows, such as 11:00 am (or 10:00 am-12:00 pm) and 6:00 pm (or 5:00 pm-7:00 pm), with a cost/charge corresponding to each time or time window. For the delivery times or time windows, the carrier system 100 and/or the retailer system/third party system 125 may determine/identify that the costs for delivery at these delivery times or within these delivery time windows will cost an additional $12.00. In one embodiment, as the specificity of the time or the time window increases, the cost may increase. This approach can be used to provide customers with greater flexibility over their pickup and delivery services, as shown in FIGS. 16 and 17. Table 2 below provides illustrative estimated pickup or delivery windows and confirmed pickup or delivery windows from which the customer can select to have an item picked up or delivered. As will be recognized, a variety of approaches and techniques can be used to adapt to various needs and circumstances.

TABLE 2

| Estimated Windows | Confirmed Windows |
|---|---|
| 11:45am-3:45pm | 11:45am-1:45pm |
| | 12:45pm-2:45pm |
| | 1:45pm-3:45pm |
| 11:30am-3:30pm | 11:30am-1:30pm |
| | 12:30pm-2:30pm |
| | 1:30pm-3:30pm |
| 2:00pm-5:45pm | 2:00pm-4:00pm |
| | 3:45PM-5:45pm |
| 1:00pm-4:15pm | 1:00pm-3:00pm |
| | 2:15pm-4:15pm |
| 8:00am-11:00pm | 8:00am-10:00am |
| | 9:00am-11:00am |
| 3:00pm-6:00pm | 3:00pm-5:00pm |
| | 4:00pm-6:00pm |
| 3:00pm-5:45pm | 3:00pm-5:00pm |
| | 3:45pm-5:45pm |
| 4:00pm-6:00pm | 4:00pm-6:00pm |

In one embodiment, the carrier system 100 and/or the retailer system/third party system 125 can present the expected, estimated, confirmed, and/or guaranteed pickup or delivery times or time windows for view and/or selection by customers (e.g., operating customer computing entities 110/120). For example, as shown in 6. Enhanced Delivery Time/Window Concepts, a customer (e.g., operating a customer computing entity 110/120) can select from a plurality of delivery times/windows and the corresponding costs (if applicable) as part of an online shopping experience (e.g., before, during, or subsequent to selection of item, placement of an item in a shopping cart, a checkout process, shipping of the item or the like. Latency may be reduced by providing customer information/data and/or shipping information/data to the carrier as early as possible (e.g., when the customer accesses the retailer's website, add an item to a cart, checkouts, and/or the like). Responsive to a selection of a delivery time and/or delivery time window, the carrier system 100 and/or the retailer system/third party system 125 can update the shipping data (e.g. pick-up, sort, delivery date and times) correspondingly for delivery at during a selected window or, in some embodiments, during the specified time within the specified window. Such selections may also determine/identify what delivery service level should be used. Further, although much of the preceding is discussed in the context of deliveries, the same is applicable to pickups.

Additional information/data regarding such time windows can be found in U.S. Pat. No. 6,701,299, U.S. Pat. No. 7,233,907, and U.S. Pat. No. 7,925,524, all of which are incorporated herein in their entireties by reference. As will be recognized, a variety of other operations and processes may be used with embodiments of the present invention. These operations and processes can be customized to adapt to various needs and circumstances.

### 6. Enhanced Delivery Time/Window Concepts

In some embodiments, an interface (e.g., browser, dashboard, application from a carrier and/or retailer) in communication with the carrier system 100 and/or retailer system/third party system 125 can be used to automatically provide and receive selection of, for example, one or more expected, estimated, confirmed, and/or guaranteed pickup or delivery times (including pickup or delivery windows). For example, a customer (e.g., a customer or customer representative operating a consignee computing entity 110 or consignor computing entity 120) may access the interface (e.g., browser, dashboard, application from a carrier and/or retailer) in communication with the carrier system 100 and/or retailer system/third party system 125, while for example, shopping online via the retailer's website, application, or the like, to view an item and one or more expected, estimated, confirmed, and/or guaranteed pickup or delivery times for the item, before, during, and/or after purchase. Furthermore, in some embodiments, the interface (e.g., browser, dashboard, application from a carrier and/or retailer) in communication with the carrier system 100 and/or retailer system/third party system 125 can be used to automatically provide and receive selection of, for example, one or more access points, for example, to which delivery can be made based on the customer location, the one or more access points being staffed (e.g., (a “brick and mortar” store or the like) or unstaffed (e.g., a “drop box” or the like). Similar to the pickup or delivery times, the access point(s) may be provided and/or viewed before, during, and/or after purchase. In some embodiments, item location and/or other item characteristics (e.g., size, special handling instructions or the like) may factor into the determination of the one or more access points.

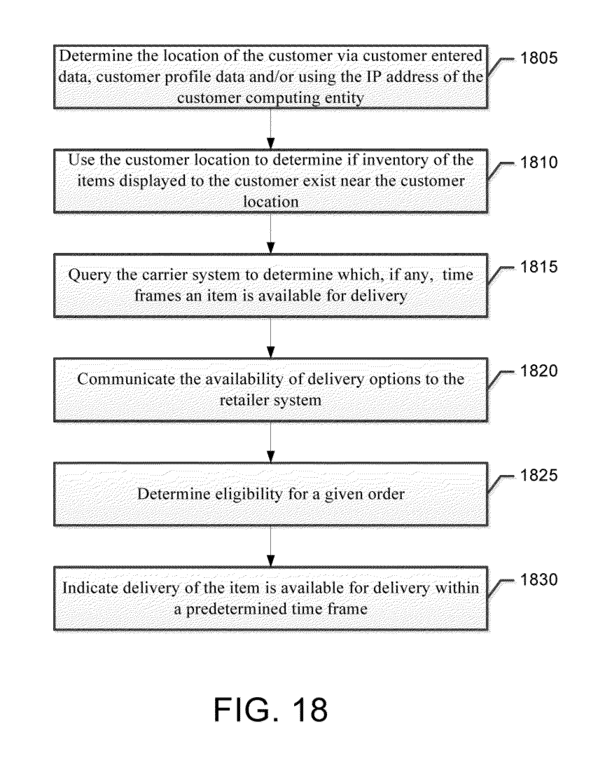

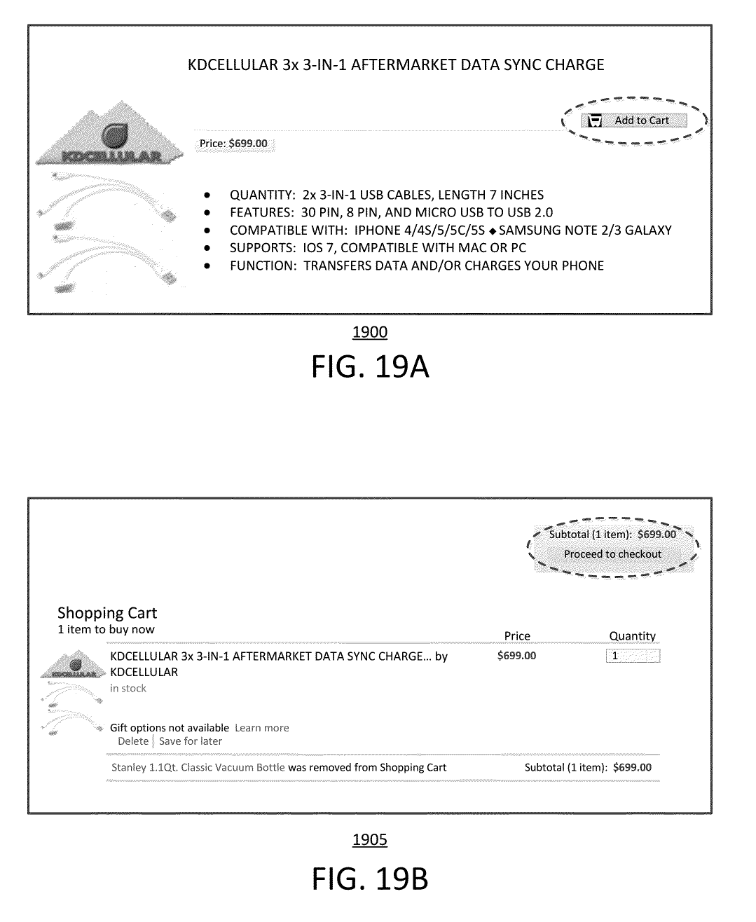

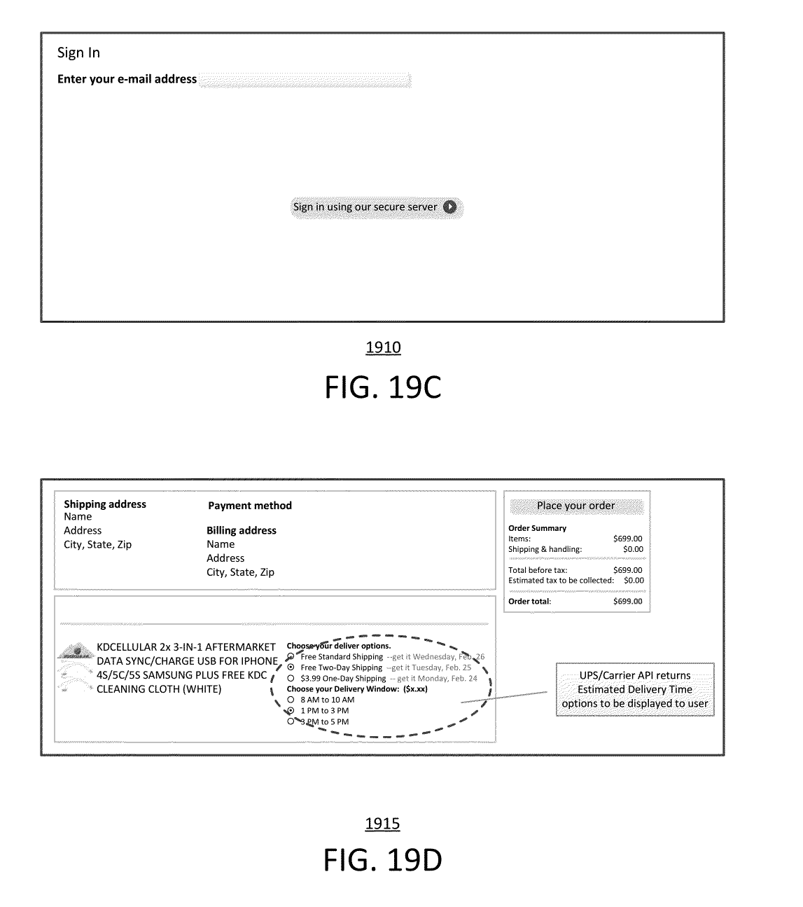

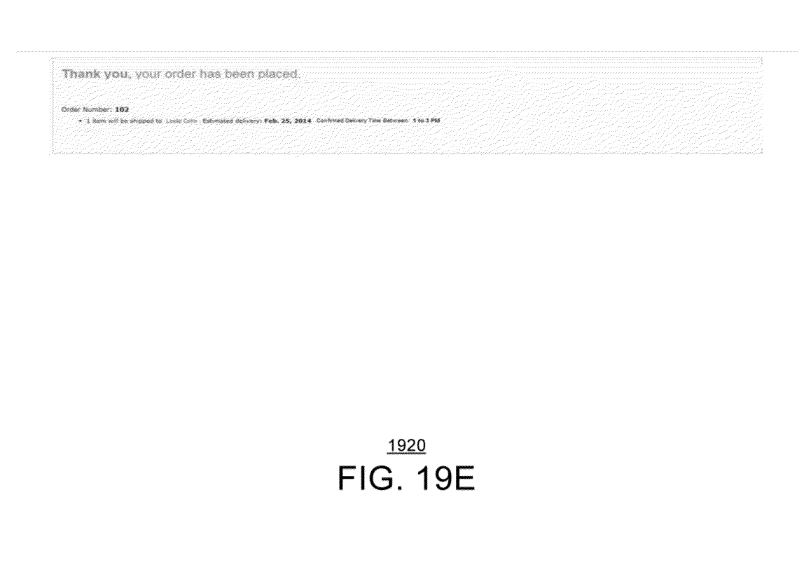

FIG. 18 shows a flowchart illustrating a process that may be performed by a retailer system/third party system 125 and/or a carrier system 100 for providing one or more delivery benefits to, for example, authenticated users as well as non-authenticated users, including but are not limited to, providing one or more delivery windows for selection, to online shoppers utilizing one of the retailer's website (e.g., vww.retailencom), a retailer login API, and/or a carrier API (e.g., Carrier Accelerated Program Enrollment API). The flowchart shown in FIG. 18 will be described with reference to example displays 1900-1950 shown in FIGS. 19A-19E. FIGS. 19A-19E show example displays 1900-1950 that may be presented by one or more display screens of one or more devices, such as those used by a user, such as a customer, consignee, consignor, retailer, or the like, which as described above, may be referred to herein as a consignee computing device 110 or consignor computing entity 120. While the example displays 19A-19E are configured to be shown on a computer monitor, laptop screen, tablet computer, or other device having similar dimensions, similar interfaces may be utilized with other types of devices (e.g., mobile telephone, “smart phone,” etc.) discussed herein and modified accordingly (e.g., for screen size, input device compatibly, ease of use, etc.). Note that the portion of the displays described herein may be labeled differently and not necessarily as shown.

In some embodiments, an authenticated or non-authenticated customer (e.g., operating a customer computing entity 110/120) may access the retailer system (e.g., shopping online via the retailer) and browse one or more items for purchase. For example, displays 1900-1915 of FIGS. 19A-19E, respectively, show a process for using a retailer website to make a purchase of a product. As is shown, FIG. 19A shows a display 1900 screen that may be displayed by a device with which an item may be viewed and purchased, by for example, selecting “Add to Cart.” FIG. 19B shows a display 1905 that may be displayed after selection of “Add to Cart,” particularly showing the “cart,” the “cart” comprising the selected item, a corresponding quantity and price as well as, in some embodiments, any other previously selected items and/or information/data indicative of items that may have been removed, prices changes, or the like. Furthermore, display 1905 may configured such that items in the cart may be purchased by selecting “Proceed to Checkout.”

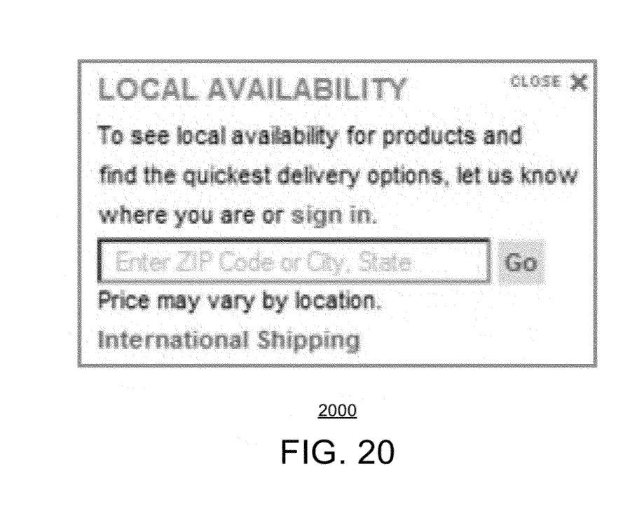

A retailer system/third party system 125 (e.g., in communication with customer computing entities 110/120 and/or carrier systems 100), as is shown in operation 1805, may include means, such as processor 205 or the like, for, determining the location of the customer. That is, location may be determined for both authenticated customers and non-authenticated customers, because, in some embodiments, benefits, such as one or more delivery windows available for selection, may be provided regardless of authentication. For example, location may be determined via customer entered data, customer profile data, and/or using the IP address or GPS functionality of the customer computing entity. For example, FIG. 19C shows a display 1910 that may be displayed by the retail system requesting an email address enabling the customer to sign into the retailer's secure server, the secure server storing customer profile data or the like, enabling the retail system 125 to determine the location of the customer. Additionally or alternatively, in some embodiments, location may be requested. FIG. 20 shows a display 2000 that may be presented by the retailer system/third party system 125 to a customer (e.g., operating a customer computing entity 110/120) displaying a pop-up window requesting customer location information/data (e.g., a zip code). In some embodiments, the retailer system may determine the customer's location before, during, or subsequent to selection of item, placement of an item in a shopping cart, a checkout process, shipping of the item or the like in order provide potential and/or available delivery windows to the customer. Whereas, in other embodiments, location may be determined later. Moreover, in some embodiments, retailer system/third party system 125 may include means, such as processor 205 or the like, for determining the authentication of a customer, which is discussed below, for providing one or more additional benefits to those consumers that are determined to be authenticated and, in some embodiments, those consumers who elect to receive/select delivery windows, or in some embodiments, access points, and are temporarily enrolled in the authentication process.

Returning to FIG. 18, in some embodiments, as customers browse for items to purchase, the retailer system may use the customer location to determine if inventory of the items displayed to the customer are available near the customer location. That is, in some embodiments, the retailer system/third party system 125, as is shown in operation 1810, may include means, such as processor 205 or the like, for, determining whether an item (e.g., a currently displayed item) is available for delivery to the customer location. For example, in some embodiments, the retailer system/third party system 125 may be configured to determine if the item is located within a predetermined distance of the location of the customer. For example, the retailer system/third party system 125 may determine whether inventory exists for an item (e.g., a clothing item) at a warehouse, retail location, and/or the like within the same geographic region (e.g., city, zip code, range of zip codes, geo-fenced area) or the like. In some embodiments, the retailer system/third party system 125 (e.g., in communication with customer computing entities 110/120 and/or carrier systems 100), as is shown in operation 1815, may include means, such as processor 205 or the like, for querying or otherwise providing a request to, for example, the carrier system 100, to determine which, if any, time frames may be available for delivery. In some embodiments, the retailer system/third party system 125 may request if delivery is available within one or more predetermined time frames. In some embodiments, retailer system/third party system 125 may include means, such as processor 205 or the like, for determining eligibility for delivery within specific time frames. The retailer system/third party system 125 (e.g., in communication with customer computing entities 110/120 and/or carrier systems 100), as is shown in operation 1820, may include means, such as processor 205 or the like, for, receiving from, for example carrier system 100, notification or communication regarding the availability of delivery options. That is, the carrier system 100 may include means for optimizing delivery logistics, including but not limited to pick-up times, driver selection, route optimization, etc.

In some embodiments, a retailer system/third party system 125 and a carrier system 100 may have established rules for delivery within predetermined time frames. For example, delivery within 24 hours may be available for orders within a given geographic area and/or received by a predetermined and/or agreed upon time. In some embodiments, the given geographic area and/or the predetermined time may be item dependent. For example, items under a certain weight (e.g., 25 lbs.) may be available for same day/time compressed delivery if ordered by a certain time (e.g., 2 pm). In this case, retailer system/third party system 125, as is shown in operation 1825, may include means, such as processor 205 or the like, for, determining eligibility for a given order with or without having to contact the carrier system 100. In some embodiments, retailer system/third party system 125 may be configured to store one or more, or in some embodiments, each of the established rules locally (e.g., database 240), and as such, need not query carrier system 100 in the determination of which of one or more time frames may be available for delivery, each of the locally stored rules received from the carrier system 100.

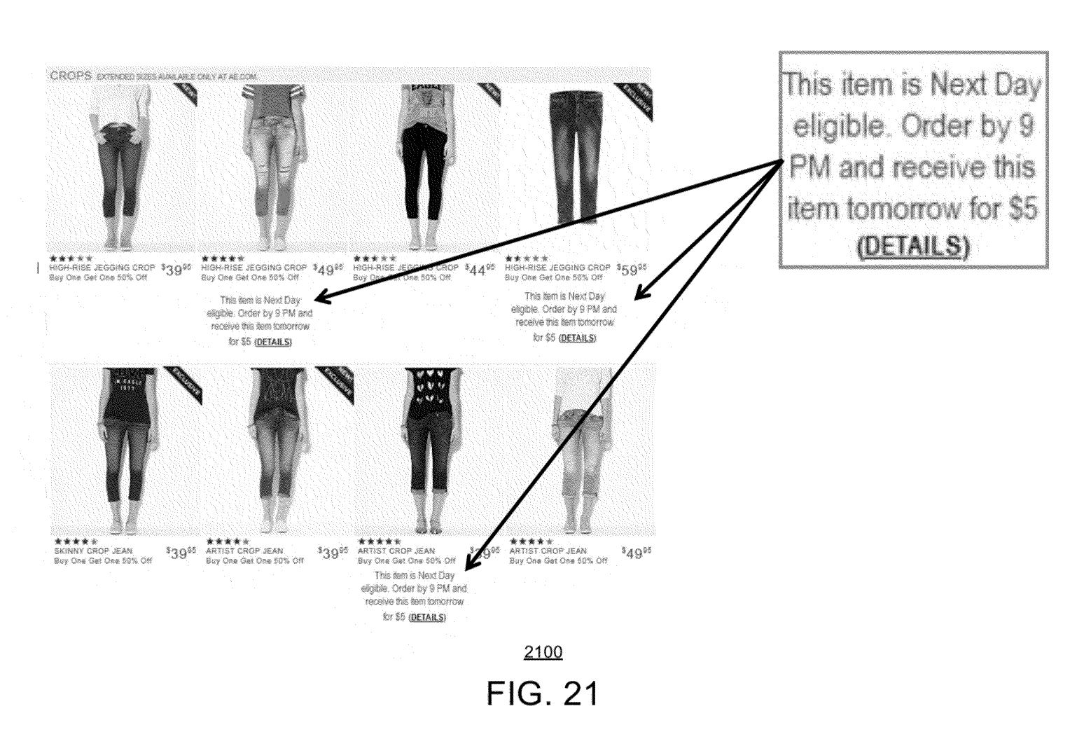

Using the response from the carrier system 100 related to inventory and/or delivery availability and/or data/information from the established rules related to inventory and delivery availability, retailer system/third party system 125 (e.g., in communication with customer computing entities 110/120 and/or carrier systems 100), as is shown in operation 1830, may include means, such as processor 205 or the like, for, providing an indication that delivery of the item is available for delivery within one or more predetermined time frames. For example, in some embodiments, as shown in FIG. 21, the retailer system/third party system 125 may provide or present a display, (e.g., display 2100), indicating that delivery by the next day is available (e.g., “This item is Next Day eligible”) before an item is purchased and while the customer is still browsing. In other embodiments, the retailer system/third party system 125 may display one or more delivery options (e.g., “FREE standard shipping, FREE Two-Day Shipping, $3.99 One-Day Shipping, or the like) and/or one or more delivery windows (e.g., 8 AM to 10 AM, 1 PM to 3 PM, 3 PM to 5 PM) related to an item or items in the cart that the customer indicated an intent to purchase by selecting “Proceed to Checkout,” as shown in display 1915 of FIG. 19D. As shown display 19D may be displayed after the customer has signed in and optionally may be configured to display the customer's shipping address, payment method, and billing address. Note that the shipping address, the payment method, and billing address each may be edited and/or changed. Each delivery option and each delivery window may be configured for selection by, for example, clicking on the selectable icon next to the desired option. FIG. 19E shows display 1920 that may be displayed after selection of “Place Your Order” and confirms the selected delivery option.

In some embodiments, the retailer system/third party system 125 and/or carrier system 100 may impose, or otherwise require a fee for each of one or more delivery options and/or access points. In some embodiments, the current time of the day, the current day of the week or the like may affect the availability and/or fee of each of one or more predetermined delivery time frames or delivery windows and/or access points. In some embodiments, the retailer system/third party system 125 may include one or more business rules requiring receipt of an order by a certain time to confirm and/or facilitate delivery of the item within the estimated delivery time and/or access point.

### A. Implementation Scenarios

In some embodiments, an interface (e.g., browser, dashboard, application from a carrier and/or retailer) in communication with the carrier system 100 and/or retailer system/ third party system 125 can be used to provide one or more delivery benefits, including in some examples, providing and receiving selection of, for example, one or more expected, estimated, confirmed, and/or guaranteed pickup or delivery times (including pickup or delivery windows), as discussed above and/or the bypassing of some portion of the validation steps conventionally required in the selection thereof. For example, a customer (e.g., a customer or customer representative operating a consignee computing entity 110 or consignor computing entity 120) may access the interface (e.g., browser, dashboard, application from a carrier and/or retailer) in communication with the carrier system 100 and/or retailer system/third party system 125, while for example, shopping online via the retailer's website, application, or the like, to view an item. In order to be provided with one or more expected, estimated, confirmed, and/or guaranteed pickup or delivery times for the item, before, during, and/or after purchase, the customer may additionally access an interface (e.g., browser, dashboard, application from a carrier and/or retailer) in communication with the carrier system 100 without having to sign in, provide additional verification, credentials, usernames, passwords, or the like.

In a first exemplary embodiment, retailer system/ third party system 125 may enroll an authenticated user in a carrier's customer pickup, delivery, and/or returns program (e.g., Carrier Program) using, for example, an Accelerated Enrollment API (e.g., Carrier Accelerated Program Enrollment API) from the carrier system 125. Subsequent to the accelerated enrollment, delivery window information/data may be returned, for example, to the carrier system 125 using a carrier system API. The user may then access the carrier system 100 (e.g., Carrier.com, m.Carrier.com, Carrier.com/m) with a, for example, mobile application provided by the carrier system 100 (e.g., the Carrier mobile App) by providing login information/data associated with the retailer system/third party system 125 (e.g., login to www.retailer.com or the like), or other customer information (e.g. personal identification, address verification, financial, mobile device, etc.) associated with the retailer system.

In a second exemplary embodiment, a retailer system/ third party system 125 may enroll a non-authenticated or a verified user in a carrier's customer pickup, delivery, and/or returns program (e.g., Carrier Program) using, for example, an Accelerated Enrollment API (e.g., Carrier Accelerated Program Enrollment API) from the carrier system 125. Subsequent to the accelerated enrollment, delivery window information/data may be returned, for example, to the carrier system 125 using a carrier system API. The user may then access the carrier system 100 (e.g., Carrier.com, m.Carrier.com, Carrier.com/m) with a, for example, mobile application provided by the carrier system 100 (e.g., the Carrier mobile App) by providing login information/data associated with the retailer system/third party system 125 (e.g., login to www.retailer.com or the like), or other customer information (e.g. personal identification, address verification, financial, mobile device, etc.) associated with the retailer system.

In a third exemplary embodiment, a retailer system/third party system 125 may enroll an authenticated user in a carrier's customer pickup, delivery, and/or returns program (e.g., Carrier Program) using, for example, an Accelerated Enrollment API (e.g., Carrier Accelerated Program Enrollment API) from the carrier system 125. Subsequent to the accelerated enrollment, delivery window information/data may be returned, for example, to the carrier system 125 using a carrier system API. The user may then access the carrier system 100 (e.g., Carrier.com, m.Carrier.com, Carrier.com/m) with a, for example, mobile application provided by the carrier system 100 (e.g., the Carrier mobile App) by providing login and password information/data associated with the carrier system 100, or, in some embodiments, other customer information (e.g. personal identification, address verification, financial, mobile device, etc.) associated with the carrier system.

In a fourth exemplary embodiment, a retailer system/third party system 125 may enroll a non-authenticated or a verified user in a carrier's customer pickup, delivery, and/or returns program (e.g., Carrier Program) using, for example, an Accelerated Enrollment API (e.g., Carrier Accelerated Program Enrollment API) from the carrier system 125. Subsequent to the accelerated enrollment, delivery window information/data may be returned, for example, to the carrier system 125 using a carrier system API. The user may then access the carrier system 100 (e.g., Carrier.com, m.Carrier.com, Carrier.com/m) with a, for example, mobile application provided by the carrier system 100 (e.g., the Carrier mobile App) by providing login and password information/data associated with the carrier system 100, or, in some embodiments, other customer information (e.g. personal identification, address verification, financial, mobile device, etc.) associated with the carrier system.

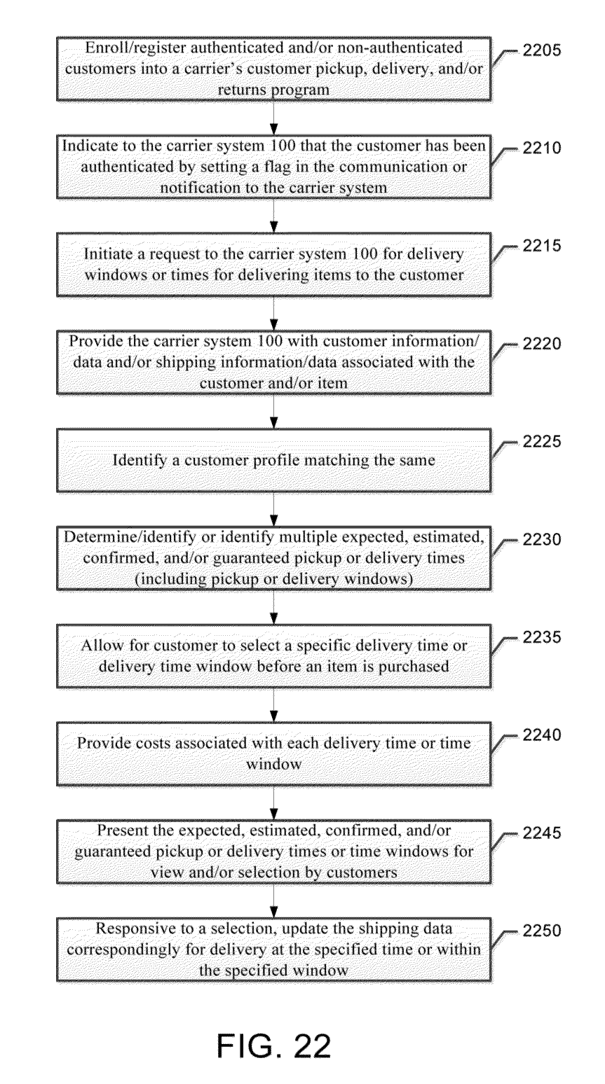

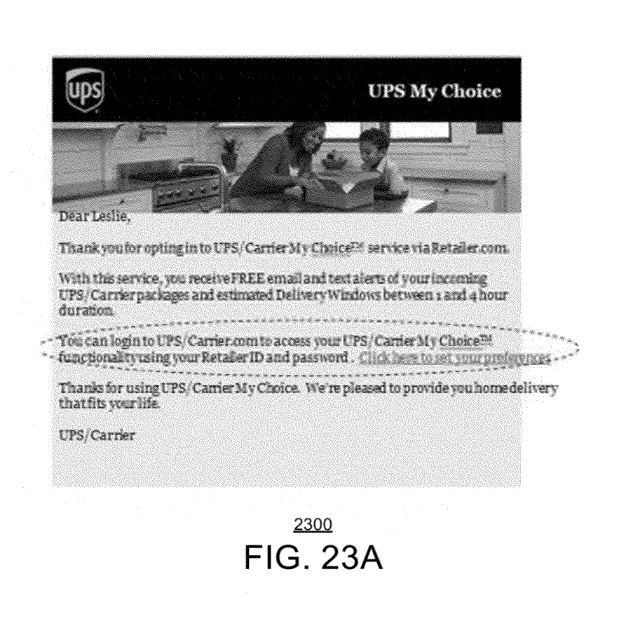

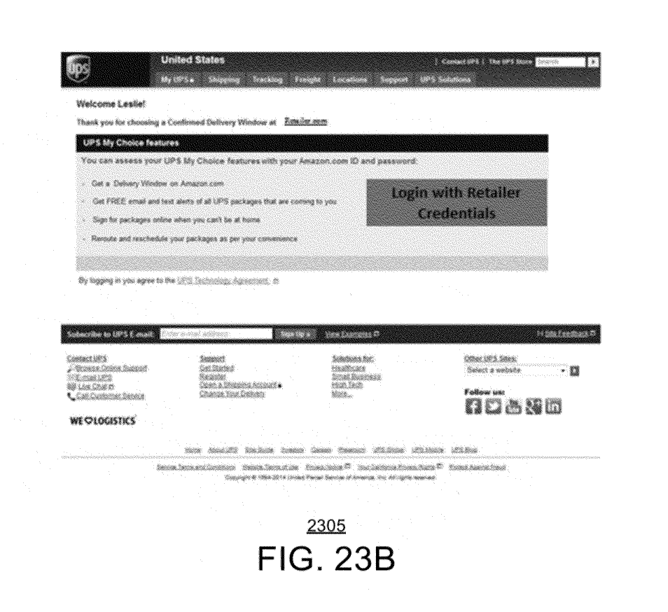

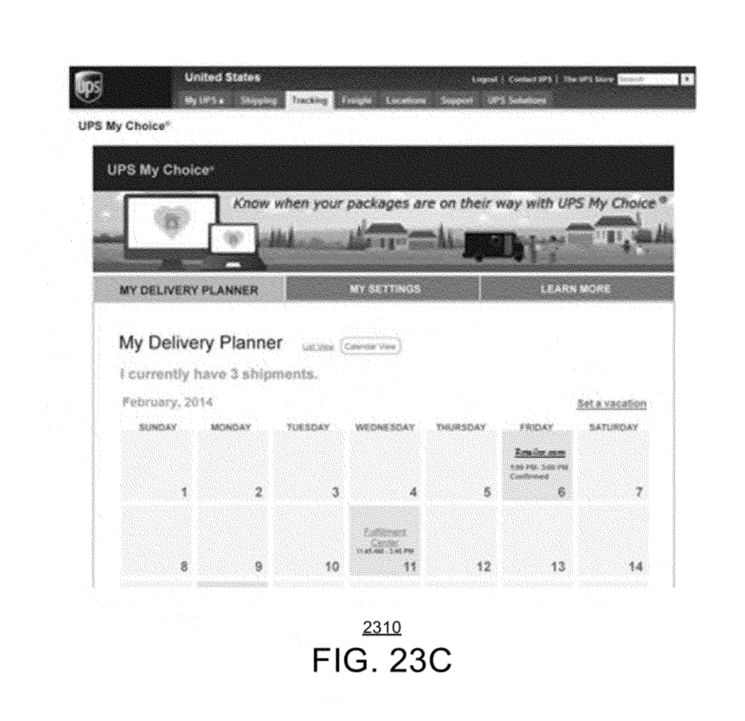

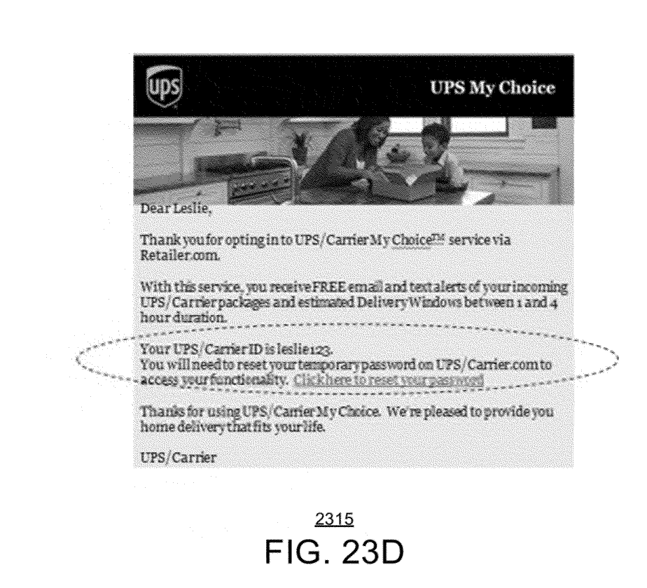

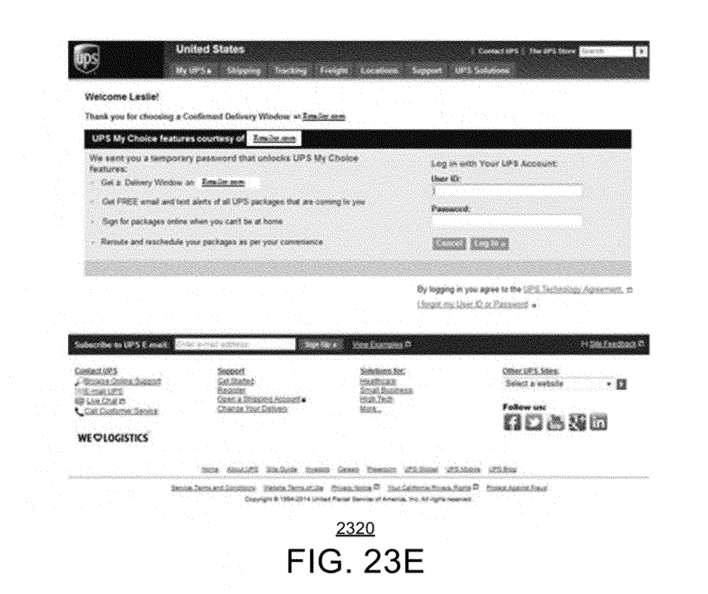

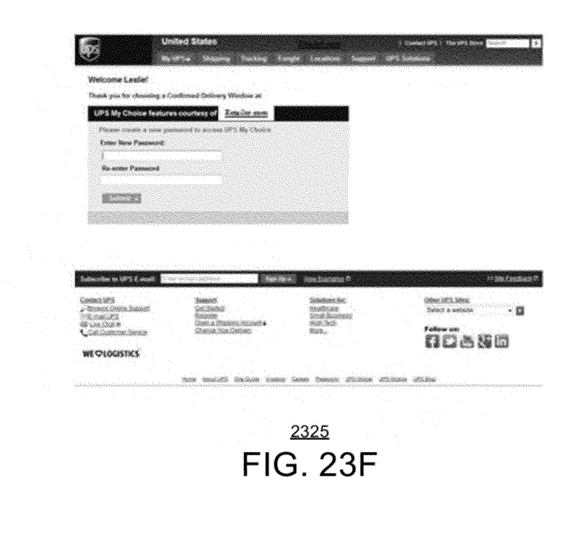

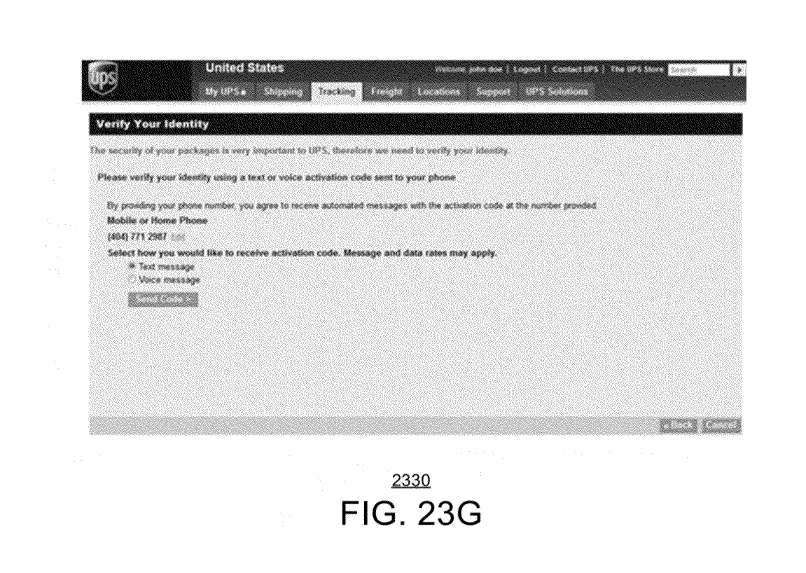

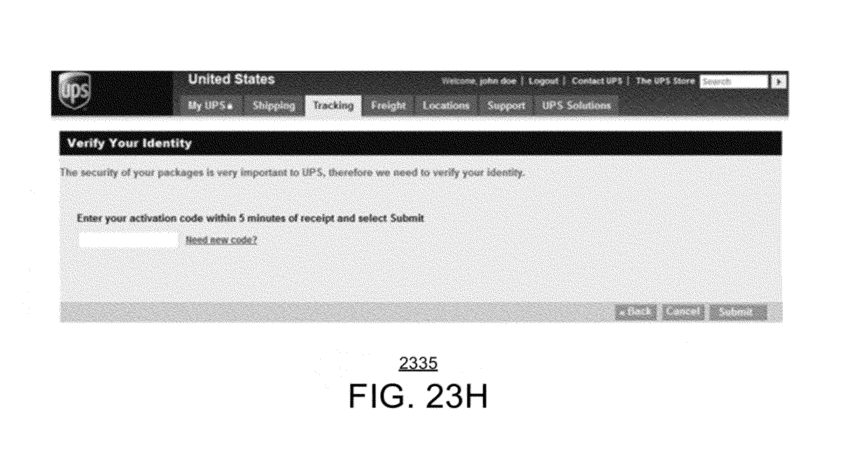

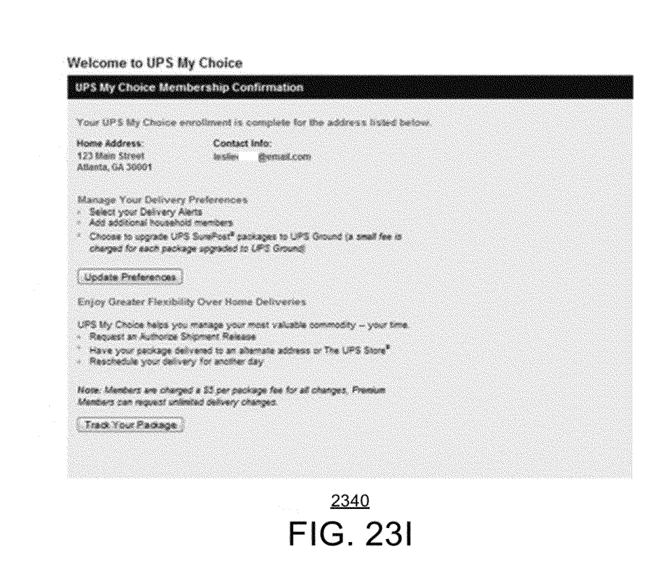

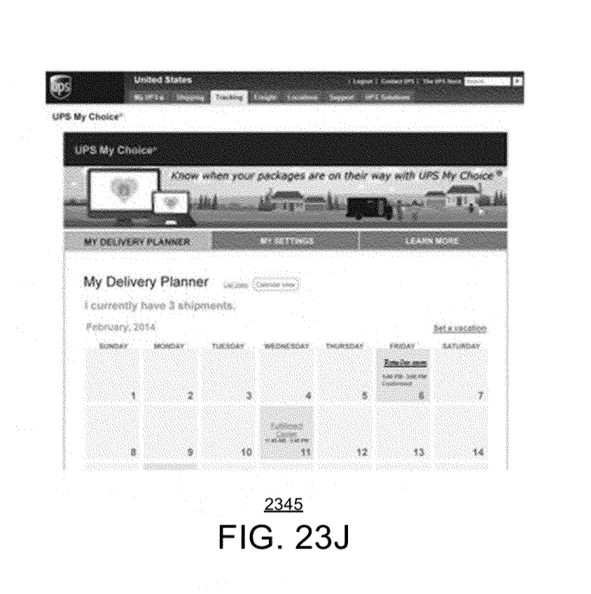

FIG. 22 shows a flowchart illustrating a process that may be performed by a retailer system/third party system 125 and/or a carrier system 100 for providing one or more delivery benefits to, for example, online shoppers utilizing any of the retailer's website (e.g., www.retailer.com), a retailer login API, and/or a carrier API (e.g., Carrier Accelerated Program Enrollment API). In some embodiments, delivery benefits may include, but are not limited to, providing delivery windows for selection and/or bypassing some portion of the validation steps in the selection thereof, as well as receiving free email or text alerts related to any incoming packages, changing, viewing, scheduling the delivery windows or the like. The flowchart shown in FIG. 22 will be described with reference to example displays 2300-1945, shown in FIGS. 23A-23J. FIGS. 23A-23J show example displays 2300-2345 that may be presented by one or more display screens of one or more devices, such as those used by a user, such as a customer, retailer, or the like, which as described above, may be referred to herein as a consignee computing device 110, consignor computing entity 120, or the like. Again, while the example displays 2300-2345 are configured to be shown on a computer monitor, laptop screen, tablet computer, or other device having similar dimensions, similar interfaces may be utilized with other types of devices (e.g., mobile telephone, “smart phone,” etc.) discussed herein and modified accordingly (e.g., for screen size, input device compatibly, ease of use, etc.). Note that the portion of the displays described herein may be labeled differently and not necessarily as shown.

In some embodiments, a retailer system/third party system 125 (e.g., in communication with customer computing entities 110/120 and/or carrier systems 100), as is shown in operation 2205, may include means, such as processor 205 or the like, for enrolling/registering authenticated and/or non-authenticated customers into a carrier's customer pickup, delivery, and/or returns program. As used herein, an authenticated customer may be a customer with whom the retailer has had past interactions and/or has confirmed the customer's identity, address, and/or the like. Thus, a non-authenticated customer may be a customer with whom the retailer has not had past interactions and/or has not confirmed the customer's identity, address, and/or the like. As described previously, authenticated customers may have access to different options that non-authenticated members do not have (including one, some, and/or all of the above described features). The enrollment/registration may be similar to that previously described in the section entitled 1. Registration.

The retailer system/third party system 125 may indicate to the carrier system 100 that the customer has been authenticated by setting a flag in the communication or notification to the carrier system 100. As such, in some embodiments, a retailer system/third party system 125 (e.g., in communication with customer computing entities 110/120 and/or carrier systems 100), as is shown in operation 2210, may include means, such as processor 205 or the like, for providing an indication to the carrier system 100, or in some embodiments, to a carrier's API, that the customer has been authenticated by setting a flag in the communication or notification. In some embodiments, by being authenticated, a customer may be registered/enrolled, bypassing the validation/fraud operations and/or processes that may be required of a non-authenticated customer. The retailer system/third party system 125 may be configured to subject non-authenticated customers to additional steps and/or provide a subs-set of all of the various options until they have been authenticated by the carrier system 100 and/or the retailer system/third party system 125. In some embodiments, the retailer system/third party system 125 may be configured for enabling an activation and/or verification process requiring, for example, login or customer information associated with customer information of the retailer system to be captured by the carrier system.

For example, FIGS. 23A-23C shows displays 2300-2310 that may be displayed in response to an indication that the customer is authenticated. Whereas FIGS. 23D-20J show displays 2315-2345, which may be displayed in response to a notification that the customer is not authenticated. As shown in FIG. 23A, display 2300 shows a display that may be displayed by a carrier system 100, a carrier system's API or the like indicating that the authenticated user may access the carrier system 100 (e.g., Carrier.com, m.Carrier.com, Carrier.com/m) using their retailer ID and password. As shown, display 2300 may display “Click Here to set your preferences” or the like and be configured to receive selection of the user's indication to proceed to the carrier system 100. FIG. 23B shows display 2305 which may be displayed upon reception of user selection and be configured to receive the retailer login information/data (e.g., username and password) to access the carrier system 100. FIG. 23C then shows a display 2310 which may be displayed upon reception of the user's retailer login information. That is, the user's access to the carrier system 100 (e.g., Carrier.com, m.Carrier.com, Carrier.com/m) may be, for example, a calendar labeled “My Delivery Planner” displaying one or more delivery windows (e.g., retailer.com, 1:00 PM-3:00 PM, confirmed). In other exemplary embodiments, one or more of the user's additional expected, estimated, confirmed, and/or guaranteed pickup or delivery times (including pickup or delivery windows) for each of one or more other participating retailer systems 125 may be displayed.

FIGS. 23D-23J shows displays 2315-2345 that may be displayed in response to an indication that the customer is not authenticated. As shown in FIG. 23D, display 2315 shows a display that may be displayed by a carrier system 100, a carrier system's API or the like indicating that the authenticated user may access the carrier system 100 (e.g., Carrier.com, m.Carrier.com, Carrier.com/m) using their carrier system 100 information/data. As shown, display 2315 may display the user's carrier system ID and a statement such as “You will need to reset your temporary password on Carrier.com to access your functionality. Click Here to set reset your password” or any statement indicating the use of the carrier system ID will be necessary to access the carrier system. The display may also be configured to receive selection of the user's indication to proceed to the carrier system 100. FIG. 23E shows display 2320 that may be displayed subsequent to selection in the display 2315 and configured to receiving a User ID and Password associated with the carrier system 100. The display may further indicate that a temporary password has been sent to the user. FIG. 23F shows display 2325 which may be displayed once the user enters the User ID and temporary password in display 2320 and selects login. Display 2325 may be configured to receive a new password by for example, indicating to the user to “Enter New Password” and “Re-Enter Password.”

FIG. 23G shows display 2330 which may be displayed once the user enters a new password. Display 2330 may be configured to provide verification of the user's identity. For example, as shown in FIG. 23G, display 2330 may be configured to display, or in some embodiments, request, a phone number and request a selection indicating how the user would like to receive an activation code (e.g., text message or voice message). Display 2300 may be configured to receive an indication to send the verification code once the user submits the requested information. FIG. 23H shows display 2335 which may be displayed subsequent to the user's input of their phone number and preferred method of receiving the verification code. The carrier system 100 may be configured to receive the user information/data and send the verification code via the selected means (e.g., text message or voice message). As shown, display 2335 may be configured to receive the activation code. Moreover, display 2335 may be configured to receive a selection form the user indicating a need to resend the activation code.

FIG. 231 shows display 2340 which may be displayed once the user enters the activation code. As shown in FIG. 231, display 2340 may be configured to display the user's home address, contact information/data or the like. Display 2340 may further be configured to allow the user to manage their delivery preferences (e.g., update preferences, select delivery alerts, add additional household members, to choose an upgraded membership level (e.g., Carrier SurePost). Display 2340 may further be configured to enable the user to track a package, request an Authorize Shipment Release, have a package delivered to an alternate address or a store associated with the carrier system 100 (e.g., The Carrier Store), and/or reschedule their delivery to another day. FIG. 23J shows display 2345 which may be displayed that may be displayed up reception of the login information. That is, the user's access to the carrier system 100 (e.g., Carrier.com, m.Carrier.com, Carrier.com/m) may be, for example, a calendar labeled “My Delivery Planner” and displaying one or more delivery windows (e.g., retailer.com, 1:00 PM-3:00 PM, confirmed). In other exemplary embodiments, one or more of the user's additional expected, estimated, confirmed, and/or guaranteed pickup or delivery times (including pickup or delivery windows) for each of one or more other participating retailer systems 125 may be displayed. As is shown, in an instance in which a retailer system/third party system 125 (e.g., in communication with customer computing entities 110/120 and/or carrier systems 100) provides an indication to the carrier system 100 that the customer has been authenticated by, for example, setting a flag in the communication or notification, many steps in the verification process may be bypassed.

Returning to FIG. 22, in some embodiments, a retailer system/third party system 125 (e.g., in communication with customer computing entities 110/120 and/or carrier systems 100), as is shown in operation 2215, may include means, such as processor 205 or the like, for initiating a request to the carrier system 100 for delivery windows or times for delivering items to the customer. For example, when a customer (e.g., operating a customer computing entity 110/120) launches an application or interface, logs into an account, selects an item for placement into an electronic shopping cart, begins to complete a sale or purchase transaction for an online transaction, and/or the like, a retailer system/third party system 125 (e.g., in communication with customer computing entities 110/120 and/or carrier systems 100), as is shown in operation 2220, may include means, such as processor 205 or the like, for providing the carrier system 100 with customer information/data and/or shipping information/data associated with the customer and/or item.

In response to receiving the customer information/data and/or the item information/data, the carrier system 100 may identify a customer profile matching the same as described in section 2. Customer and Item Matching. That is, in some embodiments, a carrier systems 100 (e.g., in communication with customer computing entities 110/120 and/or retailer system/third party system 125), as is shown in operation 2225, may include means, such as processor 205 or the like, for identifying a customer profile matching or nearly matching the customer information/data of shipping information/data provided from the retailer system/third party system 125. After identifying the correct customer profile, in some embodiments, a carrier systems 100 (e.g., in communication with customer computing entities 110/120 and/or retailer system/third party system 125), as is shown in operation 2230, may include means, such as processor 205 or the like, for determining or identifying one or more expected, estimated, confirmed, and/or guaranteed pickup or delivery times (including pickup or delivery windows) based at least in part on the customer information/data and/or the shipping information/data as described in section 5. Pickup/Delivery Times. For example, the carrier system 100 and/or the retailer system/third party system 125 may determine/identify or identify multiple expected, estimated, confirmed, and/or guaranteed pickup or delivery times (including pickup or delivery windows). In an online environment, such as when for example a customer may be shopping online via the retailer's website, application, or the like, this may allow for customers to select a specific delivery time or delivery time window before, during, or subsequent to selection of item, placement of an item in a shopping cart, a checkout process, shipping of the item or the like. For example, if the carrier system 100 and/or the retailer system/third party system 125 determines that the expected, estimated, confirmed, and/or guaranteed delivery time is, for example, 2:00 pm and/or that the applicable delivery window is 1:00 pm-3:00 pm, the carrier system 100 and/or the retailer system/third party system 125 can provide this service at no additional charge or for any amount desired or determined. However, the carrier system 100 and/or the retailer system/third party system 125 can also provide other delivery times and time windows, such as an expected, estimated, confirmed, and/or guaranteed delivery time of 11:00 am (or delivery window 10:00 am-12:00 pm) and/or an expected, estimated, confirmed, and/or guaranteed delivery time of 6:00 pm (or delivery window 5:00 pm-7:00 pm), with a cost/charge corresponding to each time or time window. As such, customers are provided with greater flexibility over their pickup and delivery services.

In some embodiments, even if a customer has not yet been registered/enrolled (e.g., a customer profile has not been created), the carrier system 100 may be able to determine/identify delivery times (including pickup or delivery windows) from the customer information/data and/or shipping information/data. As previously indicated, this determination/identification can be based on historical information/data from previous visits to the customer's location, forecasted delivery volumes for the day and/or time of delivery, weather, and/or the like.

In some embodiments, a retailer system/third party system 125 (e.g., in communication with customer computing entities 110/120 and/or carrier systems 100) or a carrier systems 100 (e.g., in communication with customer computing entities 110/120 and/or retailer system/third party system 125), as is shown in operation 2235, may include means, such as processor 205 or the like, for allowing for a customer to select a specific delivery time or delivery time window before an item is purchased, as part of the checkout process, after an item has been received by the carrier for transport, and/or the like.

In some embodiments, a retailer system/third party system 125 (e.g., in communication with customer computing entities 110/120 and/or carrier systems 100) or a carrier systems 100 (e.g., in communication with customer computing entities 110/120 and/or retailer system/third party system 125), as is shown in operation 2240, may include means, such as processor 205 or the like, for calculating and/or providing costs associated with each delivery time or time window as described in section 5. Pickup/Delivery Times. This approach may be used to provide customers with greater flexibility over their pickup and delivery services.

In some embodiments, a retailer system/third party system 125 (e.g., in communication with customer computing entities 110/120 and/or carrier systems 100) or a carrier systems 100 (e.g., in communication with customer computing entities 110/120 and/or retailer system/third party system 125), as is shown in operation 2245, may include means, such as processor 205 or the like, for providing information/data indicative of the expected, estimated, confirmed, and/or guaranteed pickup or delivery times or time windows configured for display or view and/or selection by customers following, for example, the processes and operations described in section 5. Pickup/Delivery Times. For example, as shown in FIG. 19D, a customer (e.g., operating customer computing entities 110/120) may select from a one or more or, in some embodiments, a plurality of delivery times/windows and, in some embodiments, the corresponding costs (if applicable) as part of an online shopping experience (e.g., after adding an item to a cart, at checkout, after shipment, and/or) the like. Latency may be reduced the earlier the appropriate information/data is provided to determine/identify the delivery times or windows. In some embodiments, a retailer system/third party system 125 (e.g., in communication with customer computing entities 110/120 and/or carrier systems 100) or a carrier systems 100 (e.g., in communication with customer computing entities 110/120 and/or retailer system/third party system 125), as is shown in operation 2250, may include means, such as processor 205 or the like, for, responsive to a selection, updating the shipping data correspondingly for delivery at the specified time or within the specified window.

### IV. Conclusion

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. A method for determining a delivery time frame for an item to be delivered, the method comprising:
receiving customer location information indicative of a customer location, the customer location information selected from the group consisting of entered information, customer profile information, or address information associated with a customer computing entity; and
determining one or more time frames from a plurality of carrier time frames in which delivery of the item is available based on the customer location.

2. The method according to claim 1, further comprising:
determining whether the item is available for delivery to the customer location and, in an instance in which the item is available for delivery to the customer location, determining the item location and the customer location, wherein the determination of the one or more time frames is dependent on the item location and the customer location.

3. The method according to claim 1, further comprising:
querying a carrier system to determine one or more delivery timeframes among the plurality of carrier time frames; and
receiving the one or more time frames in which delivery is available.

4. The method according to claim 1, further comprising:
receiving an indication of the item and an item location; and
providing the one or more time frames, each of the one or more time frames configured for selection, in response to reception of the customer location information and the indication of the item.

5. The method according to claim 1, further comprising:
determining the one or more time frames before, during, or subsequent to a selection of the item, placement of the item in a shopping cart, a checkout process, or shipping of the item.

6. The method according to claim 1, further comprising:
querying a set of one or more pre-established rules to deter mine a customer authentication associated with each of one or more authentication levels, the pre-established rules having been established by a carrier system; and
receiving the customer authentication associated with each of the one or more authentication levels.

7. The method according to claim 1, further comprising:
receiving, at a carrier system from a retailer system, an indication notifying the carrier system of whether a customer has been authenticated by the retailer system;
in an instance in which the indication notifying the carrier system of the authentication of the customer is received, allowing access to each of one or more features of the carrier system via login information associated with the retailer system.

8. The method according to claim 7, further comprising:
in an instance in which the indication notifying the carrier system of non-authentication of the customer is received, allowing access to a subset of features of the carrier system; and
enabling an activation process requiring login, identification, or customer information associated with the carrier system; and
initiating a full activation and validation process requiring complete login, identification, or customer information associated with the carrier system.

9. The method according to claim 1, further comprising:
receiving selection of one time frame of the one or more time frames before, during, or subsequent to a selection of the item, placement of the item in a shopping cart, a checkout process, or shipping of the item;
confirming selection of the one time frame; and
updating shipping information correspondingly for delivery with the selected time frame.

10. An apparatus for determining a delivery time frame for an item to be delivered comprising at least one processor and at least one memory including program code, the at least one memory and the program code configured to, with the processor, cause the apparatus to at least:
receive customer location information indicative of a customer location, the customer location information selected from the group consisting of entered information, customer profile information, or address information associated with a customer computing entity; and
determine one or more time frames from a plurality of carrier time frames in which delivery of the item is available based on the customer location.

11. The apparatus according to claim 10, wherein the memory stores computer-readable instructions that, when executed, cause the processor to:
determine whether the item is available for delivery to the customer location and, in an instance in which the item is available for delivery to the customer location, determining the item location and the customer location, wherein the determination of the one or more time frames is dependent on the item location and the customer location.

12. The apparatus according to claim 10, wherein the memory stores computer-readable instructions that, when executed, cause the processor to:
query a carrier system to determine one or more delivery timeframes among the plurality of time frames; and
receive the one or more time frames in which delivery is available.

13. The apparatus according to claim 10, wherein the memory stores computer-readable instructions that, when executed, cause the processor to:
receive an indication of an item and an item location; and
provide the one or more time frames, each of the one or more time frames configured for selection, in response to reception of the customer location information and the indication of the item.

14. The apparatus according to claim 10, wherein the memory stores computer-readable instructions that, when executed, cause the processor to:
determine the one or more time frames before, during, or subsequent to a selection of the item, placement of the item in a shopping cart, a checkout process, or shipping of the item.

15. The apparatus according to claim 10, wherein the memory stores computer-readable instructions that, when executed, cause the processor to:
query a set of one or more pre-established rules to deter mine a customer authentication associated with each of one or more authentication levels, the pre-established rules having been established between a carrier system and a retailer system; and
receive the customer authentication associated with each of the one or more authentication levels.

16. The apparatus according to claim 10, wherein the memory stores computer-readable instructions that, when executed, cause the processor to:
receive, at a carrier system from a retailer system, an indication notifying the carrier system of whether a customer has been authenticated by the retailer system;
in an instance in which the indication notifying the carrier system of the authentication of the customer is received, allow access to each of one or more features of the carrier system via login information associated with the retailer system.

17. The apparatus according to claim 16, wherein the memory stores computer-readable instructions that, when executed, cause the processor to:
in an instance in which the indication notifying the carrier system of non-authentication of the customer is received, allow access to a subset of features of the carrier system; and
enable an activation process requiring login, identification, or customer information associated with the carrier system; and
initiate a full activation and validation process requiring complete login, identification, or customer information associated with the carrier system.

18. The apparatus according to claim 10, wherein the memory stores computer-readable instructions that, when executed, cause the processor to:
receive selection of one time frame of the one or more time frames before, during, or subsequent to a selection of the item, placement of the item in a shopping cart, a checkout process, or shipping of the item;
confirm selection of the one time frame; and
update shipping information correspondingly for delivery with the selected time frame.

19. A computer program product comprising at least one non-transitory computer-readable storage medium having computer-readable program code portions stored therein, the computer-readable program code portions comprising for:
receiving customer location information indicative of a customer location, the customer location information selected from the group consisting of entered information, customer profile information, or address information associated with a customer computing entity; and
determining one or more time frames from a plurality of carrier time frames in which delivery of the item is available based on the customer location.

20. The computer program product according to claim 19, wherein the computer-executable program code instructions further comprise program code instructions for:
determining whether the item is available for delivery to the customer location and, in an instance in which the item is available for delivery to the customer location, determining the item location and the customer location, wherein the determination of the one or more time frames is dependent on the item location and the customer location.

21. The computer program product according to claim 19, wherein the computer-executable program code instructions further comprise program code instructions for:
querying a carrier system to determine one or more delivery timeframes among the plurality of time frames; and
receiving the one or more time frames in which delivery is available.

22. The computer program product according to claim 19, wherein the computer-executable program code instructions further comprise program code instructions for:
receiving an indication of an item and an item location; and
providing the one or more time frames, each of the one or more time frames configured for selection, in response to reception of the customer location information and the indication of the item.

23. The computer program product according to claim 19, wherein the computer-executable program code instructions further comprise program code instructions for:
determining the one or more time frames before, during, or subsequent to a selection of the item, placement of the item in a shopping cart, a checkout process, or shipping of the item.

24. The computer program product according to claim 19, wherein the computer-executable program code instructions further comprise program code instructions for:
querying a set of one or more pre-established rules to deter mine a customer authentication associated with each of one or more authentication levels, the pre-established rules having been established between a carrier system and a retailer system; and
receiving the customer authentication associated with each of the one or more authentication levels.

25. The computer program product according to claim 19, wherein the computer-executable program code instructions further comprise program code instructions for:
receiving, at a carrier system from a retailer system, an indication notifying the carrier system of whether a customer has been authenticated by the retailer system;
in an instance in which the indication notifying the carrier system of the authentication of the customer is received,
allowing access to each of one or more features of the carrier system via login information associated with the retailer system.

26. The computer program product according to claim 25, wherein the computer-executable program code instructions further comprise program code instructions for:
in an instance in which the indication notifying the carrier system of non-authentication of the customer is received, allowing access to a subset of features of the carrier system; and
enabling an activation process requiring login, identification, or customer information associated with the carrier system; and
intiating a full activation and validation process requiring complete login, identification, or customer information associated with the carrier system.

27. The computer program product according to claim 19, wherein the computer-executable program code instructions further comprise program code instructions for:
receiving selection of one time frame of the one or more time frames before, during, or subsequent to a selection of the item, placement of the item in a shopping cart, a checkout process, or shipping of the item;
confirming selection of the one time frame; and
updating shipping information correspondingly for delivery with the selected time frame.
